(19) United States
(12) Patent Application Publication
(10) Pub. No.: US 2026/0070777 A1
(43) Pub. Date: Mar. 12, 2026

(54) ARTICLES INCLUDING A MICROSTRUCTURED CURVED SURFACE, TOOLING ARTICLES, AND METHODS

(71) Applicant: Solventum Intellectual Properties Company, Maplewood, MN (US)

(72) Inventors: Ta-Hua YU, Woodbury, MN (US); Olester BENSON, JR., Woodbury, MN (US); Jodi L. CONNELL, St. Paul, MN (US); Timothy J. HEBRINK, Scandia, MN (US); Ming-Lai LAI, Afton, MN (US); Vivian W. JONES, Woodbury, MN (US); Gordon A. KUHNLEY, St. Paul, MN (US); Joseph D. WHEELDON, Boyceville, WI (US); Qunyi CHEN, Woodbury, MN (US); Anthony F. SCHULTZ, Forest Lake, MN (US); Evan D. BRUTINEL, Inver Grove Heights, MN (US); Graham M. CLARKE, Woodbury, MN (US)

(21) Appl. No.: 19/107,387

(22) PCT Filed: Jul. 18, 2023
(86) PCT No.: PCT/IB2023/057341

§ 371 Date: Feb. 27, 2025

Related U.S. Application Data
(60) Provisional application No. 63/402,631, filed on Aug. 31, 2022.

(51) Int. Cl. B81B 3/00; A61C 7/08; B29C 51/02; B29C 59/02; B33Y 80/00

(52) U.S. Cl. CPC B81B 3/0067; A61C 7/08; B29C 51/02; B29C 59/022; B29C 2059/023; B33Y 80/00

(57) ABSTRACT

The present disclosure provides a microstructured article including a thermoplastic polymer shaped to have a curve. At least a portion of the curve includes a microstructured surface of utilitarian discontinuities and the microstructured surface includes peak structures and adjacent valleys. The peak structures and the curve are formed of a single piece of the thermoplastic polymer. A method of making the microstructured articles is also provided including a) obtaining a tool shaped to include at least one of a protrusion or a concavity; b) disposing a microstructured film on at least a portion of the tool including the protrusion and/or the concavity; and c) thermoforming a single piece of thermoplastic polymer onto the tool to form a microstructured article shaped to include a curve. The curve is an inverse of the protrusion or the concavity of the tool.

### FIELD

The present disclosure generally relates to microstructured articles, tooling articles, and method of making microstructured articles.

### BACKGROUND

Certain articles with microstructured surfaces have been demonstrated to provide a reduction of microorganism (e.g., bacteria) after cleaning. It can be challenging, however, to achieve strong interfacial adhesion between microstructures and other portions of the article.

### SUMMARY

In a first aspect, a microstructured article is provided. The microstructured article comprises a thermoplastic polymer shaped to comprise a curve comprising a curvature radius of up to 20 mm, wherein at least a portion of the curve comprises a microstructured surface of utilitarian discontinuities, wherein the microstructured film comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees, and wherein the peak structures and the curve are formed of a single piece of the thermoplastic polymer.

In a second aspect, a method of making a microstructured article is provided. The method comprises a) obtaining a tool shaped to comprise at least one of a protrusion or a concavity; b) disposing a microstructured film on at least a portion of the tool including the protrusion and/or the concavity; and c) thermoforming a single piece of thermoplastic polymer onto the tool to form a microstructured article shaped to comprise a curve comprising a curvature radius of up to 20 mm. The curve is an inverse of the protrusion or the concavity of the tool and at least a portion of the curve comprises a microstructured surface of utilitarian discontinuities being an inverse of a surface of the microstructured film. The microstructured surface comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

In a third aspect, the present disclosure provides a tooling article. The tooling article comprises a tool shaped to comprise at least one of a protrusion or a concavity and a microstructured film disposed on at least a portion of the tool including the protrusion and/or the concavity. The microstructured film comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1 is a perspective review of a Cartesian coordinate system of a surface that can be utilized to describe various microstructured surfaces;

FIGS. 2A-2B are three-dimensional topographical maps of microstructured surfaces comprising an array of peak structures;

FIGS. 3A-3C are three-dimensional topographical maps of microstructured surfaces comprising an array of peak structures;

FIG. 4 is a plot of the complement of the cumulative gradient (i.e. slope) magnitude distribution (Fcc);

FIG. 5 is a plot of the complement of the cumulative X slope (Ycc);

FIG. 6 is a plot of the complement of the cumulative Y slope (Xcc);

FIG. 7 is a schematic side view of a structure;

FIG. 8A is a generalized schematic perspective view of a tool comprising a plurality of protrusions and concavities, having a shape of a dental arch;

FIG. 8B is photograph of an exemplary tooling article comprising the microstructured tooling film of Example 1 disposed on a dental arch, with the microstructured surface on the exterior of the tooling film;

FIG. 8C is a photograph of an exemplary article of Example 2, thermoformed onto the tooling article of FIG. 8B;

FIG. 8D is a photograph of the exemplary article of FIG. 8C after removal from the tooling article of FIG. 8B;

FIG. 9A is a photograph of a tooling article comprising a microstructured tooling film disposed on a dental arch, with the microstructured surface on the exterior of the tooling film and a portion of the tooling film removed near the incisor area of the dental arch;

FIG. 9B is a photograph of an article thermoformed onto the tooling article of FIG. 9A;

FIG. 9C is a photograph of the article of FIG. 9B after removal from the dental arch; and

FIG. 9D is an optical micrograph image of a portion of the interior surface of the article showing differentially microstructured areas between the location of the tooling and where a portion of the film had been removed from the dental arch.

FIGS. 10A-10C are optical micrograph images of an exemplary microstructured tooling film of Example 3;

FIGS. 11A-11B are optical micrograph images of a microstructured tooling film of Comparative Example 2;

FIGS. 12A-12B are an optical micrograph images of an exemplary article of Example 2.

FIG. 13 is a photograph of an exemplary microstructured tooling film of Example 3.

FIG. 14 is a photograph of a microstructured tooling film of Comparative Example 2.

While the above-identified figures set forth various embodiments of the disclosure, other embodiments are also contemplated, as noted in the description. In all cases, this disclosure presents the invention by way of representation and not limitation. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

### Glossary

As used herein, the term “arch” refers to a semicircular shape.

As used herein, “curvature radius” is the reciprocal of the curvature of a curve.

As used herein, “concavity” refers to a surface or an object that has a concave shape.

As used herein, “integral” refers to being made at the same time or being incapable of being separated without damaging one or more of the (integral) parts.

As used herein, “utilitarian” means that the discontinuities provide a positive contribution to the functioning of the article. For instance, easy-clean utilitarian discontinuities provide a positive contribution to the function of cleaning an article easier than an article lacking the utilitarian discontinuities. Representative examples of utilitarian discontinuities include, but are not limited to, cube-corner elements and parallel linear prisms with planar facets.

As used herein, “draw down” as used herein means extending a molten resin as it is being thermoformed. The draw down is characterized by a draw down ratio (DDR), which is the ratio of the surface area of a part to the footprint of the part. In general, the draw-down ratio for thermoplastic materials used herein is suitably from 1.1 to 3.

As used herein, the term “crack” refers to a break in a surface of a material or a change in a thickness of a material, each without complete separation of the material.

As used herein, the term “macrocrack” refers to a crack having at least one dimension that is greater than 250 microns in length.

As used herein, the term “microcrack” refers to a crack in which each dimension is 250 microns in length or shorter.

As used herein, the term “essentially free” in the context of a composition being essentially free of a component, refers to a composition containing less than 1% by weight (wt. %), 0.5 wt. % or less, 0.25 wt. % or less, 0.1 wt. % or less, 0.05 wt. % or less, 0.001 wt. % or less, or 0.0001 wt. % or less of the component, based on the total weight of the composition.

As used herein, “thermoplastic” refers to a polymer that flows when heated sufficiently above its glass transition point and become solid when cooled.

As used herein, “thermoset” refers to a polymer that permanently sets upon curing and does not flow upon subsequent heating. Thermoset polymers are typically crosslinked polymers.

As used herein, the term “glass transition temperature” (Tg), of a polymer refers to the transition of a polymer from a glassy state to a rubbery state and can be measured using Differential Scanning Calorimetry (DSC), such as at a heating rate of 10° C. per minute in a nitrogen stream. When the Tg of a monomer is mentioned, it is the Tg of a homopolymer of that monomer. The homopolymer must be sufficiently high molecular weight such that the Tg reaches a limiting value, as it is generally appreciated that a Tg of a homopolymer will increase with increasing molecular weight to a limiting value. The homopolymer is also understood to be substantially free of moisture, residual monomer, solvents, and other contaminants that may affect the Tg. A suitable DSC method and mode of analysis is as described in Matsumoto, A. et. al., J. Polym. Sci. A., Polym. Chem. 1993, 31, 2531-2539.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

Although articles with specific microstructure features are useful for reducing the initial formation of a biofilm, particularly for medical articles; in the case of other articles, such microstructured surfaces can be difficult to clean. This is surmised to be due at least in part to the bristles of a brush or fibers of a (e.g., nonwoven) wipe being larger than the space between microstructures. It has been found that some types of microstructured surfaces exhibit better microorganism (e.g., bacteria) removal when cleaned, even in comparison to smooth surfaces. The article is typically not a sterile implantable medical article. Rather, the microstructured surface typically comes in contact with people and/or animals as well as other contaminants (e.g., dirt). Some representative articles include for example surfaces or component of a medical article, a dental article, an orthodontic article (e.g., an orthodontic aligner), a vehicular article, an electronic article, a personal care article, a cleaning article, an athletic article, a food preparation article, a child care article, or an architectural article.

As noted above, it can be challenging to achieve strong interfacial adhesion between two different material materials, for instance when the materials are thermoformed together. It has been discovered that it is possible to form an article that includes a curved microstructured surface from just one material, using thermoforming. Stated another way, the microstructured surface is integral to the curve of the thermoplastic polymer, as opposed to being a separate microstructured surface that has been attached to the curve of the thermoplastic polymer.

In a first aspect, a microstructured article is provided. The microstructured article comprises a thermoplastic polymer shaped to comprise a curve comprising a curvature radius of up to 20 millimeters (mm). At least a portion of the curve comprises a microstructured surface of utilitarian discontinuities, wherein the microstructured surface comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees, and wherein the peak structures and the curve are formed of a single piece of the thermoplastic polymer. The peak structures and the curve are formed of a single piece of the thermoplastic polymer.

In contrast to a curved surface, a flat surface has a curvature radius of infinity. In some embodiments, the curve comprises a minimum curvature radius of 0.5 mm, such as 0.5 mm or greater, 0.6 mm, 0.7 mm, 0.8 mm, 0.9 mm, 1.0 mm, 1.25 mm, 1.5 mm, 1.75 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm or greater; and 20.0 mm or less, 19.5 mm, 19.0 mm, 18.5 mm, 18.0 mm, 17.5 mm, 17.0 mm, 16.5 mm, 16.0 mm, 15.5 mm, 15.0 mm, 14.5 mm, 14.0 mm, 13.5 mm, 13.0 mm, 12.5 mm, 12.0 mm, 11.5 mm, or 11.0 mm or less.

The microstructured surface typically provides a log 10 reduction of microorganism (e.g., bacteria) of at least 2, 3, 4, 5, 6, 7, or 8 after cleaning. Regardless of whether the microstructured surface is mechanically cleaned with a wipe or brush and/or cleaned by applying an antimicrobial solution to the microstructured surface, the microstructured surface provides improved removal of microorganism (e.g., bacteria) in comparison to surfaces lacking the microstructures.

In a second aspect, a method of making a microstructured article is provided. The method comprises a) obtaining a tool shaped to comprise at least one of a protrusion or a concavity; b) disposing a microstructured film on at least a portion of the tool including the protrusion and/or the concavity; and c) thermoforming a single piece of thermoplastic polymer onto the tool to form a microstructured article shaped to comprise a curve comprising a curvature radius of up to 20 mm. The curve is an inverse of the protrusion or the concavity of the tool and at least a portion of the curve comprises a microstructured surface of utilitarian discontinuities being an inverse of a surface of the microstructured film. The microstructured article can be any article according to the first aspect.

Accordingly, a microstructured surface can be imparted to an article having at least one curved surface by thermoforming a single piece of thermoplastic polymer onto a tool having a protrusion, in which a microstructured film is disposed on at least one of a protrusion or a concavity, with the microstructures located on the film opposite the protrusion, the concavity, or both.

Variations in how the steps of the method are performed are contemplated. For instance, the microstructured film may be attached to the thermoplastic polymer and steps b) and c) may be performed at least partially simultaneously. Optionally, the microstructured film is disposed on the tool according to step b) by thermoforming the microstructured film onto the tool simultaneously with step c). In some methods, the microstructured film is attached (e.g., by thermoforming) to an exterior surface of the tool, including over at least a portion of a protrusion and/or a concavity. Suitable methods may comprise thermoforming a thermoplastic polymer onto the microstructured base film at a temperature below the melt temperature of the peak structures of the microstructured (e.g., tooling) film. In some embodiments, vacuum forming may be used in combination with thermoforming, also known as dual vacuum thermoforming (DVT).

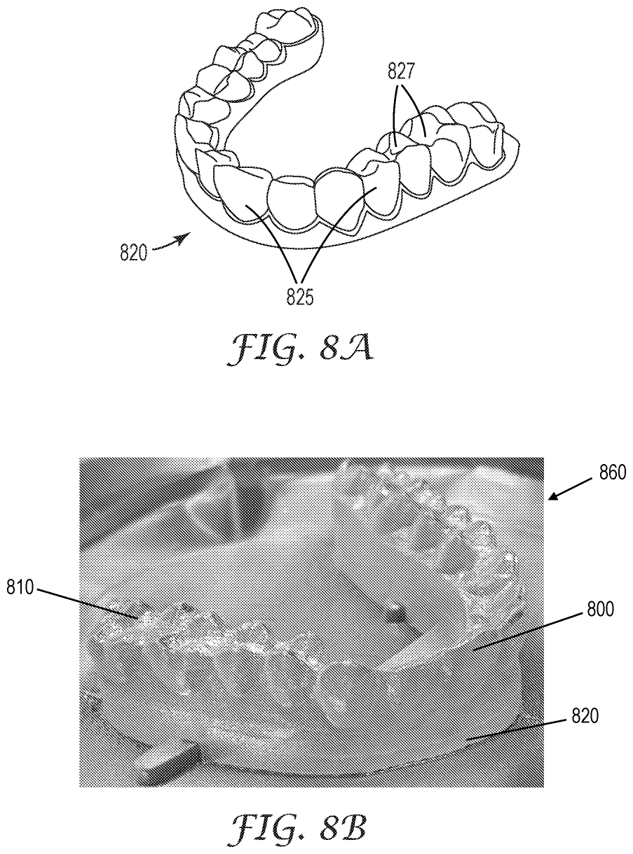

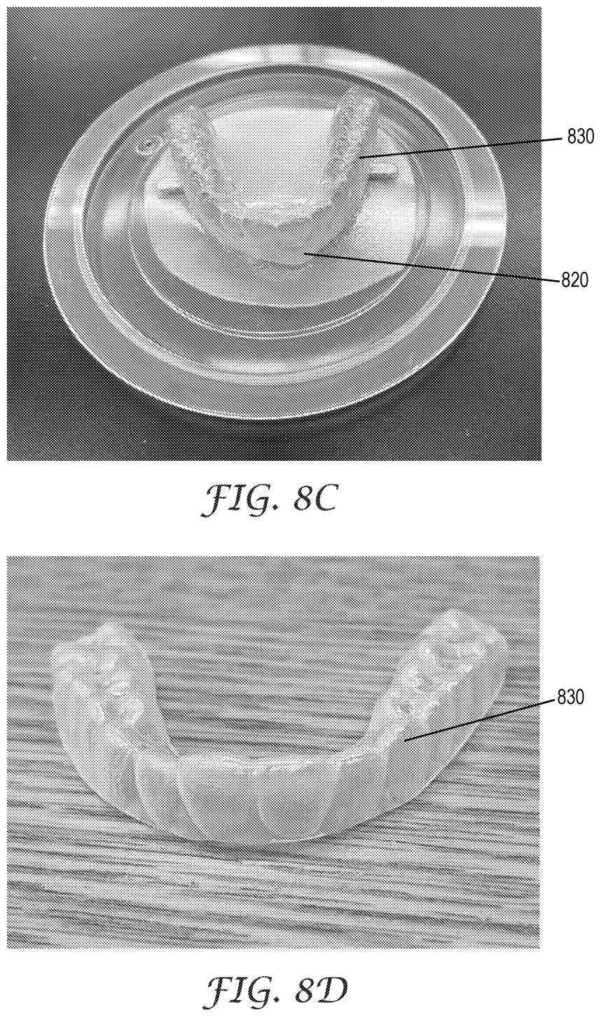

Any tool shape can be used to provide a portion of material that extends beyond, above, or below a planar surface, to impart a curve into a final article thermoformed onto at least one of a protrusion or a concavity of the tool, in which the (e.g., first) curve of the article is the inverse of the protrusion or the concavity. One suitable example is a dental arch (see, e.g., FIG. 8A). Dental arches are well known to be used as a tool in forming a dental tray for an individual (e.g., a dental tray can include a dental aligner, a night guard, a mouth guard, a treatment tray, complete or partial dentures, a tooth cap, or the like). A dental aligner may allow for repositioning misaligned teeth for improved cosmetic appearances and/or dental function. A night guard may be worn by a user to minimize damage to teeth during tooth grinding. A mouth guard may be, for example, a sports mouth guard that may or may not be formed to a user's mouth with heat. A treatment tray may allow administration of a medication to oral surfaces, e.g., teeth whitening, remineralization, gum disease treatments, or the like. In some embodiments, the dental tray may provide aesthetic appeal by providing color (e.g., whitening).

An advantage of forming a microstructured article according to the present disclosure includes being able to employ a (e.g., standard) microstructured film with any custom-made tool (such as a dental arch prepared for a particular individual), and then create an integral custom article having a microstructured surface. Tools can readily be formed by making one or more molds of a shape of interest, via additive manufacturing (e.g., using a digital scan of the desired shape), or other processes. In certain methods, step a) of the method comprises making the tool using an additive manufacturing process, e.g., stereolithography (SLA).

An overall thickness of exemplary microstructured films can vary, such as an average thickness of 25 microns or greater, 30, 40, 50, 60, 70, 80, 90, 100, 120, 140, 160, 180, 200, 220, 240, or 260 microns or greater; and 400 microns or less, 380, 360, 340, 320, 300, 280, 250, 225, 200, 175, or 150 microns or less. In select embodiments, an average thickness of a microstructured film may be 25 to 380 microns or 50 to 260 microns. It was unexpectedly found that in some cases, an average thickness of 380 microns or less contributed to a microstructured film that is more resistant to macrocracks when thermoformed than the same microstructured film having a larger average thickness.

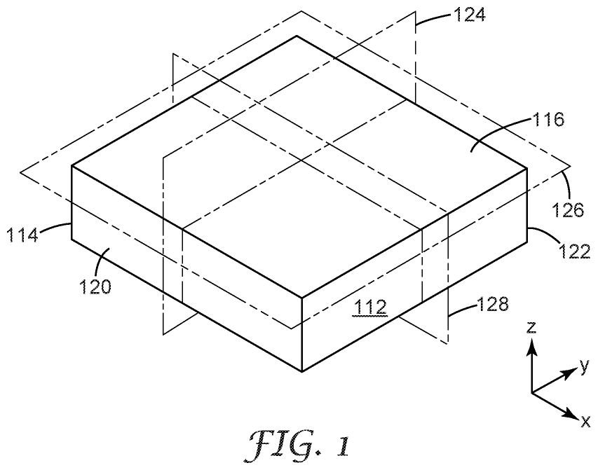

Suitable microstructured films useful as tooling films for methods according to the present disclosure have an inverse microstructure to the desired microstructure of the final microstructured article. Such desired microstructure present on a surface of an article is as described in detail below with respect to FIGS. 1-7:

With reference to FIG. 1, a microstructured surface can be characterized in three-dimensional space by superimposing a Cartesian coordinate system onto its structure. A first reference plane 124 is centered between major surfaces 112 and 114. First reference plane 124, referred to as the y-z plane, has the x-axis as its normal vector. A second reference plane 126, referred to as the x-y plane, extends substantially coplanar with surface 116 and has the z-axis as its normal vector. A third reference plane 128, referred to as the x-z plane, is centered between first end surface 120 and second end surface 122 and has the y-axis as its normal vector.

In some embodiments, the microstructured surfaces are three-dimensional on a macroscale. However, on a microscale (e.g., surface area that includes at least two adjacent microstructures with a valley or channel disposed between the microstructures) the base layer/base member can be considered planar with respect to the microstructures. The width and length of the microstructures are in the x-y plane and the height of the microstructures is in the z-direction. Further, the base layer is parallel to the x-y plane and orthogonal to the z-plane.

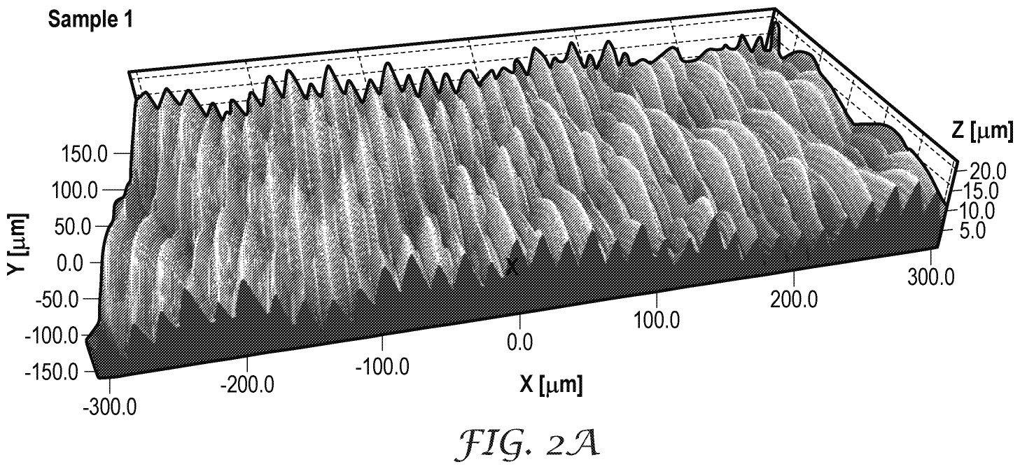

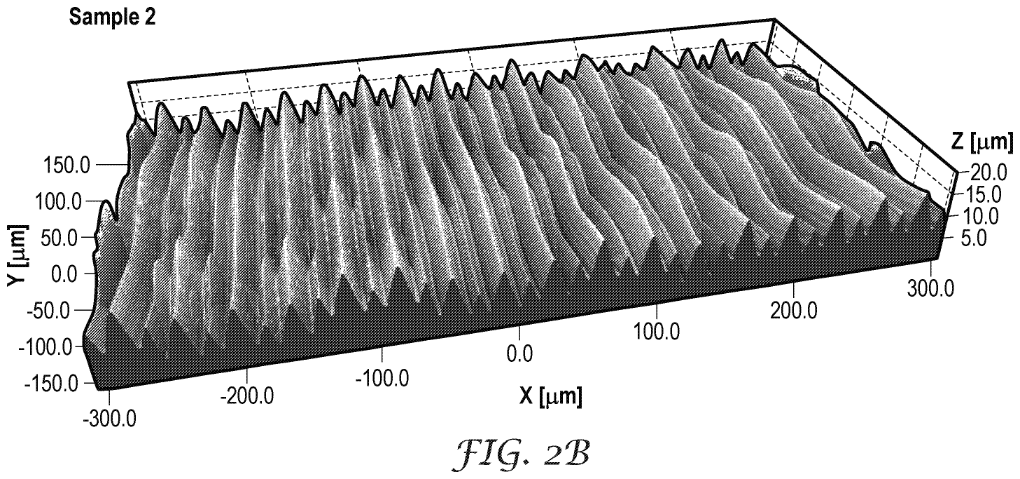

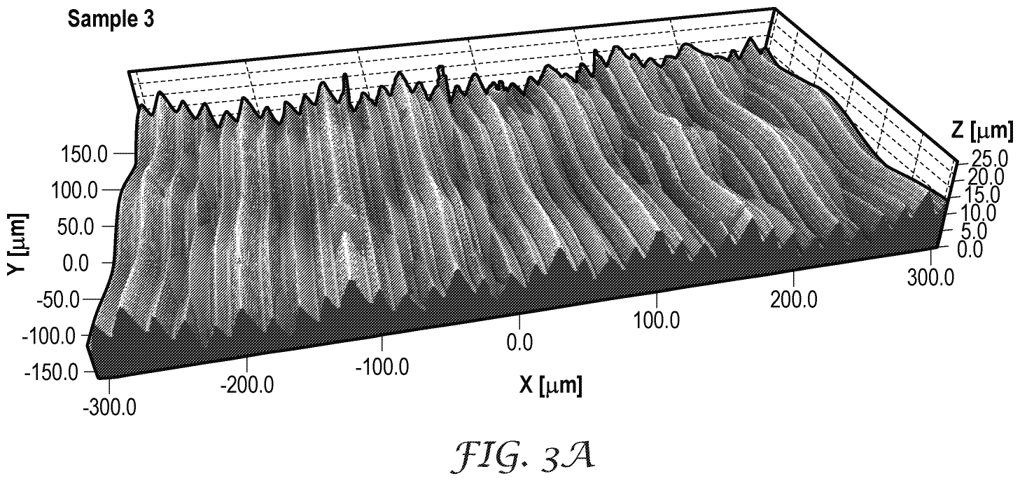

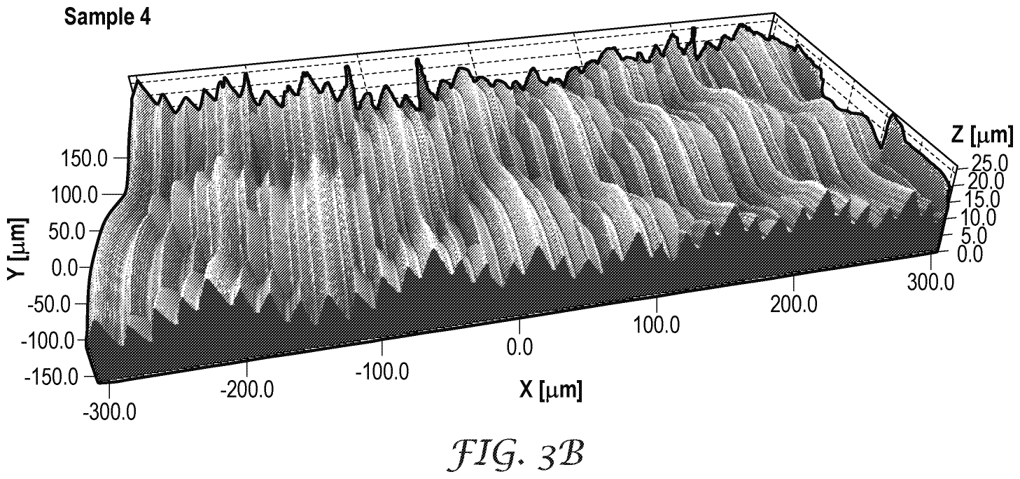

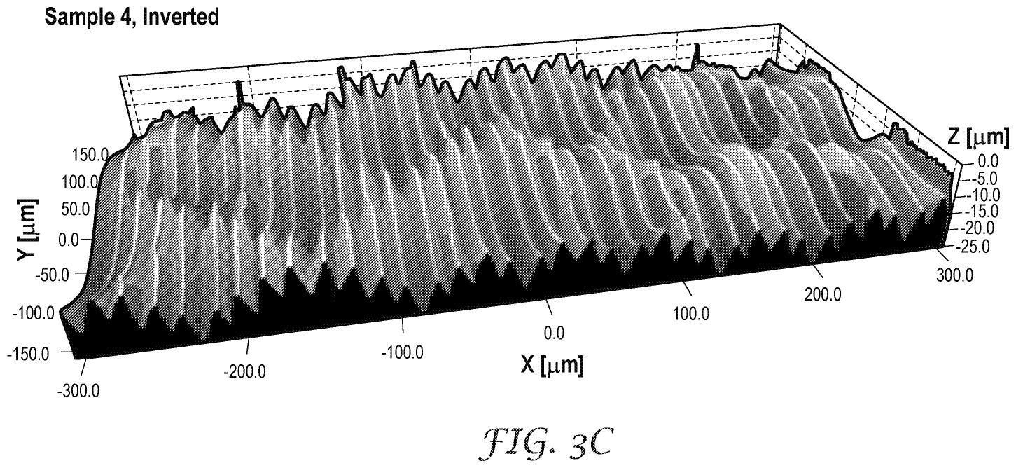

Presently described are more complex microstructured surfaces, such as illustrated by FIGS. 2A-2B and 3A-3C. The microstructured surfaces can be made using any suitable fabrication technique. For example, the microstructures can be fabricated using microreplication from a tool. The tool may be fabricated using any suitable fabrication method, such as by using engraving or diamond turning. Exemplary methods are known in the art, such as described in U.S. Pat. No. 8,888,333; WO 2000/048037; U.S. Pat. Nos. 7,140,812; 7,350,442 and 7,328,638 (Gardiner); incorporated herein by reference.

Formation of such microstructured surfaces is described in detail in PCT Application Publication No. 2023/105372 (Jones et al.), incorporated herein by reference in its entirety. Briefly, a cutting tool system can be used to cut a tool which can be used to produce films with microstructured surfaces of the disclosure. A cutting tool system employs a thread cut lathe turning process and includes a roll that can rotate around and/or move along a central axis by a driver, and a cutter for cutting the roll material. The cutter is mounted on a servo and can be moved into and/or along the roll along the x-direction by a driver. In general, the cutter can be mounted normal to the roll and central axis and be driven into the engravable material of roll while the roll is rotating around the central axis. The cutter can be then driven parallel to the central axis to produce a thread cut. The cutter can be simultaneously actuated at high frequencies and low displacements to produce features in the roll that when microreplicated result in microstructured surfaces of the disclosure.

The servo can be a fast tool servo (FTS) and can include a solid state piezoelectric (PZT) device, often referred to as a PZT stack, which rapidly adjusts the position of the cutter. Rotary movements produced by the driver are synchronized with translational movements produced by the driver to accurately control the resulting shapes of the microstructures. To prepare the tools for creating the exemplary microstructured film surfaces of FIGS. 2A-3C, the cutter was shaped to have a rounded tip with radius that ranged between 1 and 3 microns and an apex angle beta of 80 degrees (±5 degrees). The surface of the tool typically has a surface roughness of less than 50, 40, 30, or 20 nm. Thus, the surface of the microstructures can have this same surface roughness. It is appreciated that the surface roughness of the tool/surface of the microstructures does not include the roughness contributed by the microstructures and thus is not the same as the roughness of the microstructured surface.

The rotation of the roll along the central axis and the movement of the cutter along the x-direction while cutting the roll material defines a thread path around the roll that has a pitch P along the central axis. As the cutter moves along a direction normal to the roll surface to cut the roll material, the width of the material cut by the cutter changes as the cutter moves or plunges in and out. The cutter is angularly adjusted and vertically displaced in such a fashion to create a thread path that may have some element of over-cutting that eliminates portions of the previously created undulating, pseudo-random pattern(s). This process of angular adjustment and vertical displacement is repeated 3-7 times, or however many are needed, to engrave the entire surface of the roll with a pattern. The engraved roll serves as the tool for preparing films with microstructured surfaces that are a negative replication of the microstructured surface of the tool.

Although this cutting method is described with respect to rotation of a roll, randomizing the displacement in the y-direction and/or randomizing the displacement in the x-direction can also be utilized to cut a planar surface. Likewise, overcutting can also be utilized to cut a planar surface. It is also appreciated that some of the thread paths formed by the cutting tool may not incorporate randomized displacement or overcutting. For example, portions of the array of FIGS. 2A-3C may comprise a regular repeating pattern such as a linear array of prisms.

In some embodiments, a single cutter is used for cutting the array of microstructures. In other embodiments, more than one cutter is used for cutting the array of microstructures. For example, taller peaks may be formed with a cutter having a rounded tip and shorter peaks may be formed with a cutter having sharp or less rounded tips.

Further, although this cutting method is exemplified with respect to modifying the fabrication of an array of linear prisms, these same principles of randomizing the displacement in the y-direction alone and/or randomizing the displacement in the x-direction and/or overcutting can also be utilized to modify the fabrication of other microstructured arrays such as cube corner elements including preferred geometry cube corner elements; both of which are described in WO 2021/033151 (Connell et al.), incorporated herein by reference. In this embodiment, the microstructured surface may be characterized as comprising modified cube corner structures or modified preferred geometry cube corner structures.

FIGS. 2A-2B and 3A-3C are perspective views of illustrative (e.g., micro)structured surfaces comprising an array of peak structures according to the present disclosure. Notably, the cross-sectional view of the peak structures shows that the peak structures have a triangular cross section. In some embodiments, the surfaces of FIGS. 2A-2B and 3A-3C may be characterized as “modified” linear prisms. The peak structures comprise facets, or in other words faces, that form continuous surfaces in the same direction. When the microstructured surface comprises an array of modified cube corner structures the peak structures comprise facets that form semi-continuous surfaces in the same direction, as described in WO 2021/033151. When the microstructured surface comprises an array of modified preferred geometry cube corner structures the peak structures comprise facets that form both continuous and semi-continuous surfaces in the same direction, as described in WO 2021/033151.

When a microstructured surface comprises a regular repeating pattern, various dimensions such has peak height and maximum valley width can be determined by a cross-section orthogonal to the y-axis. Various angles such as the apex angle and side wall angle can also be determined by a cross-section orthogonal to the y-axis. However, when the microstructured surface is not a regular repeating pattern, or in other words is a more complex microstructured surface, multiple cross sections may be utilized to determine these parameters. Further, when the microstructure surface comprises peaks and valleys with different peak heights, different valley depths, different angles, etc. these parameters may more commonly be expressed for example by a minimum, maximum, or average value. The (micro)structures surfaces, as illustrated by FIGS. 2A-2B and 3A-3C can be characterized as having greater variability or in other words greater randomness as compared to the linear prisms of WO 2021/033151.

In contrast to the linear prisms of WO 2021/033151, the (e.g., modified linear prism) microstructured surface of each of FIGS. 2A-2B and 3A-3C comprises peaks and/or valleys of different heights. Further, the (e.g., modified linear prism) microstructured surfaces of FIGS. 2A-2B and 3A-3C comprise peaks and/or valleys of different widths. The minimum and maximum valley height, valley width, peak height and peak width of the microstructured surfaces of FIGS. 2A-2B and 3A-3B are reported in the following tables. Samples 1-4 correspond to Examples 1-4 of application number PCT Application Publication No. 2023/105372 (Jones et al.).

Valley Dimensions

| | Minimum | Maximum | Minimum | Maximum |
|---|---|---|---|---|
| | Valley | Valley | Valley | Valley |
| Sample | Height | Height | Width | Width |
| Sample 1 | 3.75 | 8.16 | 9.08 | 17.33 |
| Sample 2 | 7.40 | 12.40 | 11.50 | 16.50 |
| Sample 3 | 3.65 | 8.27 | 7.45 | 17.40 |
| Sample 4 | 6.86 | 10.73 | 11.56 | 18.15 |

Notably the valley structures vary in height (difference between the minimum and maximum) by at least 1, 2, 3, 4 or 5 microns. In some embodiments, the valley structures vary in height by no greater than 20, 10, 15, or 5 microns. Notably the valley structures vary in width (difference between the minimum and maximum) by at least 1, 2, 3, 4, 5, 6, 7, 8, 9, or 10 microns. In some embodiments, the valley structures vary in height by no greater than 20, 10, 15, or 5 microns.

Peak Dimensions

| | Minimum | Maximum | Average | Minimum | Maximum |
|---|---|---|---|---|---|
| | Peak | Peak | Peak | Peak | Peak |
| Sample | Height | Height | Height | Width | Width |
| Sample 1 | 11.3 | 15.0 | 11.7 | 9.1 | 19 |
| Sample 2 | 10.7 | 11.2 | 9.8 | 9.9 | 18.2 |
| Sample 3 | 10.8 | 15.6 | 10.9 | 10.8 | 16.5 |
| Sample 4 | 15.1 | 19.7 | 13.3 | 10.1 | 17.8 |

Notably the peak structures vary in height (difference between the minimum and maximum) by at least 1, 2, 3, 4 or 5 microns. In some embodiments, the peak structures vary in height by no greater than 20, 10, 15, or 5 microns. Notably the peak structures vary in width (difference between the minimum and maximum) by at least 1, 2, 3, 4, 5, 6, 7, 8, 9, or 10 microns. In some embodiments, the peak structures vary in height by no greater than 20, 10, 15, or 5 microns.

It is appreciated that the amount of variation can be a function of the size. Stated otherwise, the amount of variation is typically at least 10, 15, 20, 25, 30, 35, 40, 45, or 50% of the average dimension (e.g., peak height, peak width, valley height, valley width, etc.) In some embodiments, the amount of variation is less than 45, 40, 35, 30, 25, 20, 15%. Thus, when the microstructures surface has an average dimension of 10 microns, the amount of variation typically ranges from 1 to 5 microns. Likewise, when the microstructured surface has an average dimension of 1 micron, the amount of variation typically ranges from 0.1 to 0.5 microns.

FIG. 3C is a negative replication or in other words inverse of the surface of FIG. 3B. A negative replication can be made, for example, by casting and cure a polymerizable resin onto a metal tool, such as nickel, nickel-plated copper or brass. The tool preferably has a surface energy that allows clean removal of the polymerized material from the tool.

Upon removing the cured polymerizable resin from the metal tool, the resulting film will have a microreplicated surface wherein the peak structures of the tool correspond to valleys, or in other words cavities, in the film and the valleys of the tool correspond to peak structures in the films. It is to be understood that the microstructured film should comprise a material that will not melt or otherwise deform during the thermoforming process of forming the article such that the utilitarian discontinuities of the microstructured surface of the film maintain their shapes and impart the inverse of their shapes to a surface of the final article.

For this embodiment, the peak dimensions of the structured surface of FIG. 3C are the same as the valley dimensions described for Sample 4 of FIG. 3B. Further, the valley dimensions of the structured surface of FIG. 3C are the same as the peak dimensions of Sample 4, depicted by FIG. 3B.

The complex surfaces of the present disclosure were characterized using surface analysis. Topographic data was collected using a VK-200 Keyence Laser Scanning Confocal Microscope (Keyence Corporation, Itasca, IL). A stitched image was generated using the native image assembly software provided with the microscope. An array of 35 individual images (using a 150× Nikon objective) was used to produce a roughly 300×600 micrometer dataset. The dataset was further analyzed using the software package Digital Surf Mountains Map (Digital Surf, Besancon, France) to measure surface roughness parameters and to produce the 3-dimensional surface-plots of FIGS. 2A-2B and 3A-3C.

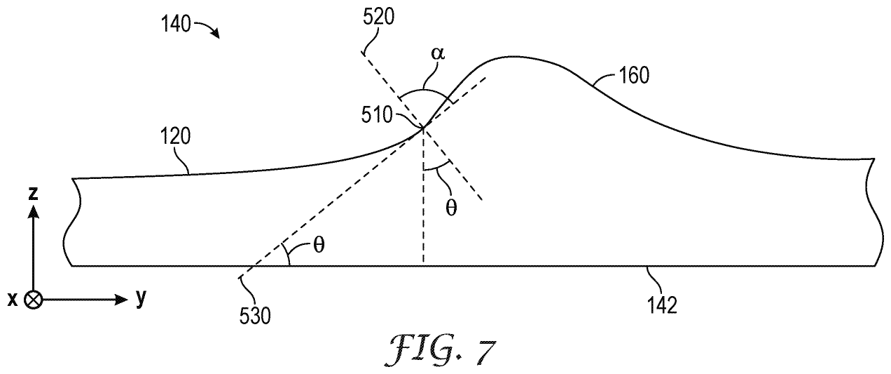

FIG. 7 is a schematic side-view of (micro)structure 160 of (micro)structured surface 120. Structure 160 has a slope distribution across the surface of the structure. For example, the microstructure has a slope θ at a location 510 where θ is the angle between normal line 520 which is perpendicular to the microstructure surface at location 510 (α=90 degrees) and a tangent line 530 which is tangent to the microstructure surface at the same location. Slope θ is also the angle between tangent line 530 and major surface 142 of the matte layer.

The slope of the (micro)structures, slope of the (micro)structured surface 120 was first taken along an x direction, and then along a y direction, such that:

$$X - slope = \frac{\partial H ( x , y )}{\partial x} , and \qquad Equation 1$$

$$Y - slope = \frac{\partial H ( x , y )}{\partial y} \qquad Equation 2$$

where, H(x,y)=the height profile of the surface.

Average x-slope and y-slope were evaluated in a 2 micron interval centered at each pixel. In different embodiments the micron interval may be chosen to be smaller or larger, so long as a constant interval is used with sufficient resolution for the microstructure size. The interval selected is less than the minimum peak width of the structure. In some embodiments, the ratio of the interval to the minimum peak width is at least 3:1, 4:1 or 5:1. Therefore, for smaller structures, smaller intervals would be selected and typically larger intervals for larger structures. Each pixel has a slope and each structure typically has more than one set of x, y coordinates and thus more than one calculated slope value. When a micro-sized interval is selected for evaluating the slope of a microstructured surface, the presence of nanostructures typically does not significantly change the Fcc of the microstructured surface. For example, a 200 nm nanostructure changes the coordinates of a 10 micron microstructure by 2%. From the x-slope and y-slope data, it is possible to determine a gradient magnitude from following Equation 3.

$$GradientMagnitude = \sqrt{{( \frac{\partial H ( x , y )}{\partial x} )}^{2} + {( \frac{\partial H ( x , y )}{\partial y} )}^{2}} \qquad Equation 3$$

Average gradient magnitude was then capable of being evaluated in a 6 μm×6 μm box centered at each pixel. Gradient magnitude was generated within a bin size of 0.5 degrees. Gradient magnitude distribution may be written as N_{G}. It should be understood that in order to find the angle degree value of the x-slope, y-slope and gradient magnitude angles that corresponds to the values above, the arctangent of the values in Equations 1, 2, and 3 should be taken. Another characterization of the surface, is the Complement Cumulative Distribution (F_{CC}(θ)), defined as the fraction (or percentage by multiplying the fraction by 100%) of the gradient magnitudes that are greater than or equal to a particular angle θ. Complement Cumulative Distribution (F_{CC}(θ)), is defined as

$${F}_{CC} ( θ ) = \frac{{\sum }_{q = θ}^{∞} {N}_{G} ( θ )}{{\sum }_{q = 0}^{∞} {N}_{G} ( θ )} \qquad Equation 4$$

Therefore, when it is stated that a certain percentage of the structured surface has a slope magnitude that is less than a certain number of degrees, this characterization is derived from the F_{CC}(θ) in Equation 4. Gradient magnitude corresponds to a combination of the x and y-slopes, and therefore, gradient magnitude may be understood as a general slope magnitude. It should be understood that the terms “gradient magnitude” and “slope magnitude” may be used interchangeably throughout this description and these terms should be understood to have the same meaning. When the total surface is microstructured, such as depicted by FIGS. 2A-2B and 3A-3C and the interval selected is less than the minimum peak width of the microstructures as previously described, the Fcc of the total surface is also the Fcc of the microstructured surface and the Fcc of the microstructures.

X-slope distributions (Xcc), Y-slope distributions (Ycc) and F(cc) were calculated for embodied microstructured surfaces, as illustrated by FIGS. 2A-2B and 3A-3C.

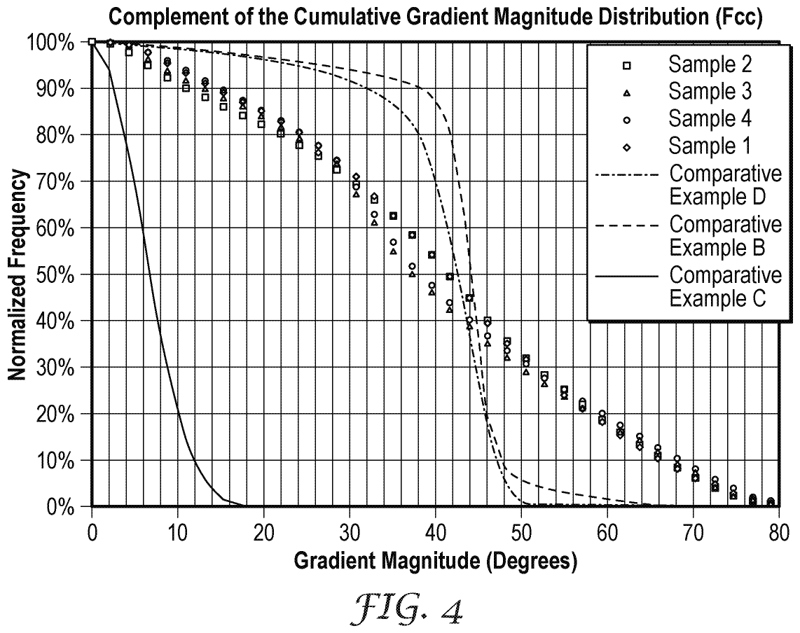

FIG. 4 is a plot of the complement of the cumulative gradient (i.e., slope) magnitude distribution (Fcc) that was calculated from the topographic data of the surfaces of FIGS. 2A-2B and 3A-3B as compared to comparative examples. Comparative Example A is a representative brightness enhancing film (e.g., Example 1 of WO 2021/033162). Comparative Example B is a representative cube corner film (e.g., Example 20 of WO 2021/033162). Notably, the microstructures of these comparative microstructured surfaces have a narrow distribution of slope. 90% of the microstructures of the surface of Comparative Example A and B have a slope of at least 30 degrees. 80% of the microstructures of the surface of Comparative Example A have a slope of at least 45 degrees (i.e., half the apex angle); whereas 80% of the microstructures of the microstructured surface of Comparative Example B have a slope of at least 40 degrees (i.e., half the apex angle). Less than 5% of the microstructures of both Comparative Example A and B have a slope less than 20 degrees. Further less than 5% of the microstructures have a slope greater than 50 degrees. For regular repeating patterns, such as Comparative Example A and B, the slope calculated from topographic data obtained from surface analysis can be substantially the same as the side wall angle as can be calculated from a cross section.

Notably, the surfaces illustrated by FIGS. 2A-2B and 3A-3C have a much broader distribution of slope. Notably, the structured surface comprises a plurality of structures having a complement cumulative slope magnitude distribution (Fcc) such that at least 30, 40, 50, 60, 70, 80 or 90% of the structures have a slope greater than 10 degrees. Further, in some embodiments, less than 80% of the structures have a slope greater than 35 degrees. In some embodiments, the structured surfaces described herein, illustrated by FIGS. 2A-2B and 3A-3C, comprise a plurality of structures having a complement cumulative slope magnitude distribution (Fcc) that meet one or more of the following criteria:
a) at least 10, 20, 30, 40, 50, 60, 70 or 80% of the structures have a slope greater than 20 degrees;
b) at least 10, 20, 30, 40, 50, 60, or 70% of the structures have a slope greater than 30 degrees;
c) at least 10, 20, 30, 40 or 50% of the structures have a slope greater than 40 degrees;
d) at least 10, 20, or 30% of the structures have a slope greater than 50 degrees;
e) at least 10 or 20% of the structures have a slope greater than 60 degrees;
f) less than 20, 10% of the structures have a slope greater than 70 degrees;
g) less than 50, 40, 30 or 20% of the structures have a slope greater than 60 degrees;
h) less than 50 or 40% of the structures have a slope greater than 50 degrees;
i) less than 70, 60, or 50% of the structures have a slope greater than 40 degrees;
j) less than 90 or 80% of the structures have a slope greater than 30 degrees; and
k) less than 90% of the structures have a slope greater than 20 degrees.

The complement cumulative slope magnitude distribution (Fcc) of FIG. 3C, i.e., the negative replication of FIG. 3B, can also be characterized by the same complement cumulative slope magnitude distribution (Fcc) criteria as just described. The structured surfaces, illustrated by FIGS. 2A-2B and 2A-2C, may be characterized by various combinations of the complement cumulative slope magnitude distribution (Fcc) criteria just described and in some embodiments all the criteria just described.

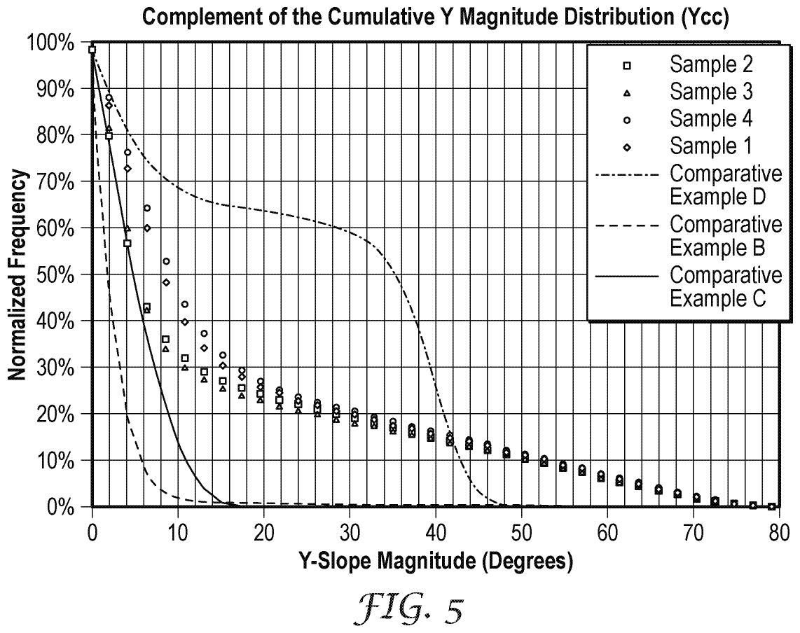

FIG. 5 is a plot of the complement of the cumulative gradient (i.e., slope) magnitude distribution (Ycc) of structured surfaces, illustrated by FIGS. 2A-2B and 3A-3B. These surfaces comprise a plurality of structures having a complement cumulative slope magnitude distribution (Ycc) wherein at least 20, 25, 30, 35, 40, 45, or 50% of the structures have a slope greater than 10 degrees and less than 55, 50, 45, 40, 35, 30, 25 or 20% of the structures have a slope greater than 30 degrees. In some embodiments, the structured surfaces described herein, illustrated by FIGS. 2A-2B and 3A-3B, comprise a plurality of structures having a complement cumulative slope magnitude distribution (Ycc) that meet one or more of the following criteria:
a) at least 10 or 20% of the structures have a slope greater than 20 degrees;
b) at least 10 or 20% of the structures have a slope greater than 30 degrees;
c) at least 10 or 15% of the structures have a slope greater than 40 degrees;
d) at least 10% of the structures have a slope greater than 50 degrees;
e) at least 5% of the structures have a slope greater than 60 degrees;
f) less than 10 or 5% of the structures have a slope greater than 70 degrees;
g) less than 20 to 10% of the structures have a slope greater than 60 degrees;
h) less than 50, 40, 30, 20 or 10% of the structures have a slope greater than 50 degrees;
i) less than 90, 80, 70, 60, 50, 40, 30 or 20% of the structures have a slope greater than 40 degrees;
j) less than 90, 80, 70, 60, 50, 40, or 30% of the structures have a slope greater than 20 degrees; and
k) less than 90, 80, 70, 60, 50, 40, or 30% of the structures have a slope greater than 10 degrees.

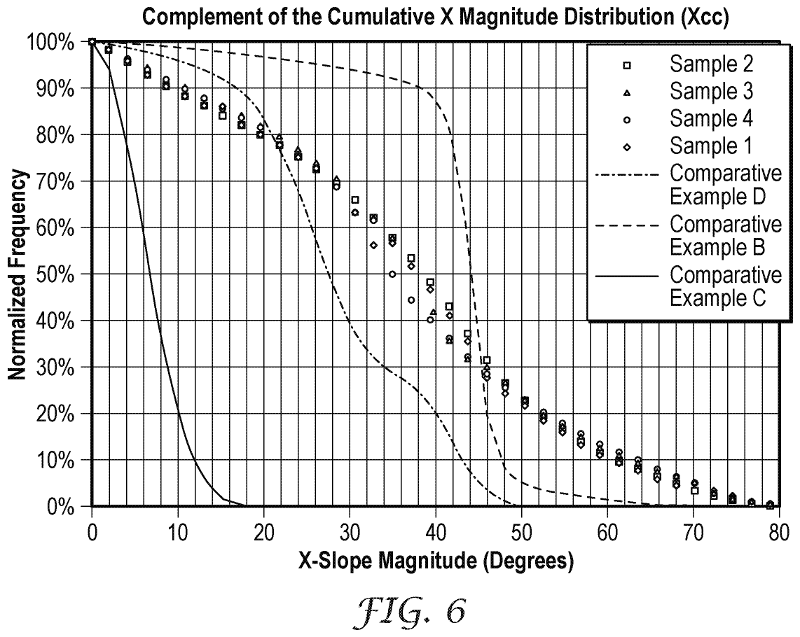

FIG. 6 is a plot of the complement of the cumulative gradient (i.e., slope) magnitude distribution (Xcc) of structured surfaces, illustrated by FIGS. 2A-2B and 3A-3B. These surfaces comprise a plurality of structures having a complement cumulative slope magnitude distribution (Xcc) wherein at least 45, 50, or 60% of the structures have a slope greater than 30 or 35 degrees; and less than 85 or 80% of the structures have a slope greater than 40 degrees. In some embodiments, the structured surfaces described herein, illustrated by FIGS. 2A-2B and 3A-3B, comprise a plurality of structures having a complement cumulative slope magnitude distribution (Xcc) that meet one or more of the following criteria:
a) at least 10, 20, 30, 40, 50, 60, 70 or 80% of the structures have a slope greater than 10 degrees;
b) at least 10, 20, 30, 40, 50, 60, or 70% of the structures have a slope greater than 20 degrees;
c) at least 10, 20, 30, 40, 50 or 60% of the structures have a slope greater than 40 degrees;
d) at least 10 or 20% of the structures have a slope greater than 50 degrees;
e) at least 10% of the structures have a slope greater than 60 degrees;
f) less than 20, 10% of the structures have a slope greater than 70 degrees;
g) less than 50, 40, 30 or 20% of the structures have a slope greater than 60 degrees;
h) less than 50, 40, or 30% of the structures have a slope greater than 50 degrees;
i) less than 90, 80, or 70% of the structures have a slope greater than 30 degrees; and
j) less than 90 or 80% of the structures have a slope greater than 20 degrees.

It is appreciated that the structured surface of FIG. 3C can also be characterized by the same complement cumulative slope magnitude distribution (Xcc) and (Ycc) criteria as just described.

Various other surface roughness parameters, Sa (Roughness Average), Sq (Root Mean Square), Sku (Surface Kurtosis), and Sbi (Surface Bearing Index), Svi (Valley Fluid Retention Index) were calculated from the topographic images (3D). Prior to calculating roughness, a plane correction was used “Subtract Plane” (1^{st} order plane fit form removal).

The following table describes S parameters of some representative examples and comparative examples. Notably some of the comparative examples are also described in WO 2021/033151.

| | Sa | Sq | | | |
|---|---|---|---|---|---|
| Sample/Example | [nm] | [nm] | Sbi | Svi | Sbi/Svi |
| Sample 1 | 2613 | 3215 | 0.75 | 0.110 | 7 |
| Sample 2 | 2445 | 2975 | 0.56 | 0.095 | 6 |
| Sample 3 | 2893 | 3577 | 0.33 | 0.096 | 3 |
| Sample 4 | 3549 | 4352 | 0.67 | 0.096 | 7 |
| Example 19 of | 1899 | 2215 | 0.53 | 0.086 | 6 |
| WO2021/033162 | | | | | |
| BEF epoxy | | | | | |
| Example 20 of | 10496 | 12504 | 0.97 | 0.039 | 25 |
| WO2021/033162 | | | | | |
| Cube Corner epoxy | | | | | |
| Example 1 of | 1961 | 2263 | 1.95 | 0.072 | 27 |
| WO2021/033162 | | | | | |
| BEF polymerized | | | | | |
| resin | | | | | |
| Example 6 of | 27327 | 32252 | 3.92 | 0.063 | 62 |
| WO2021/033162 | | | | | |
| Example 7 of | 5846 | 6620 | 2.80 | 0.064 | 44 |
| WO2021/033162 | | | | | |
| Example 8 of | 27289 | 32142 | 3.13 | 0.107 | 29 |
| WO2021/033162 | | | | | |
| Comp. B of | 366 | 457 | 0.28 | 0.092 | 3 |
| WO2021/033162 | | | | | |
| Smooth epoxy | | | | | |
| Comp. A of | 30 | 63 | 0.10 | 0.120 | 1 |
| WO2021/033162 | | | | | |
| Smooth Polymerized | | | | | |
| Resin | | | | | |
| Comp. E of | 41627 | 42389 | 7.1 | 0.017 | 417 |
| WO2021/033162 | | | | | |
| Square Wave | | | | | |
| Comp. F of | 21002 | 21428 | 1.22 | 0.013 | 95 |
| WO2021/033162 | | | | | |
| Square Wave | | | | | |

The Roughness Average, Sa, is defined as:

$${S}_{a} = \frac{1}{MN} {\sum }_{k = 0}^{M - 1} {\sum }_{l = 0}^{N - 1} \vert z ( {x}_{k} , {y}_{l} ) \vert$$

where M and N are the number of data points X and Y.

Although smooth surfaces can have a Sa approaching zero, the comparative smooth surfaces that were found to have poor microorganism removal after cleaning had an average surface roughness, Sa, of at least 10, 15, 20, 25 or 30 nm. The average surface roughness, Sa, of the comparative smooth surfaces was less than 1000 nm (1 micron). In some embodiments, Sa of the comparative smooth surface was at least 50, 75, 100, 125, 150, 200, 250, 300, or 350 nm. In some embodiments, Sa of the comparative smooth surface was no greater than 900, 800, 700, 600, 500, or 400 nm.

The average surface roughness, Sa, of the microstructured surfaces having improved microorganism removal after cleaning was 1 micron (1000 nm) or greater. In some embodiments, Sa was at least 1100 nm, 1200 nm, 1300 nm, 1400 nm, 1500 nm, 1600 nm, 1700 nm, 1800 nm, 1900 nm, or 2000 nm (2 microns). In some embodiments, Sa of the microstructured surfaces was at least 2500 nm, 3000 nm, 3500 nm, 4000 nm or 5000 nm. In some embodiments, Sa of the microstructured surfaces was at least 10,000 nm, 15,000 nm, 20,000 nm or 25,000 nm. In some embodiments, Sa of the microstructured surfaces having improved microorganism removal after cleaning was no greater than 40,000 nm (40 microns), 35,000 nm, 30,000 nm, 15,000 nm, 10,000 nm, or 5,000 nm.

In some embodiments, Sa of the microstructured surface is at least 2 or 3 times the Sa of a smooth surface. In other embodiments, Sa of the microstructured surface is at least 4, 5, 6, 7, 8, 9, or 10 times the Sa of a smooth surface. In other embodiments, Sa of the microstructured surface is at least 15, 20, 25, 30, 35, 40, 45, 50 times the Sa of a smooth surface. In other embodiments, Sa of the microstructured surface is at least 100, 200, 300, 400, 500, 600, 700, 800, 900, or 1000 times the Sa of a smooth surface.

The Root Mean Square (RMS) parameter Sq, is defined as:

$${S}_{q} = \sqrt{\frac{1}{MN} {\sum }_{k = 0}^{M - 1} {\sum }_{l = 0}^{N - 1} {[ z ( {x}_{k} , {y}_{l} ) ]}^{2}}$$

where M and N are the number of data points X and Y.

Although the Sq values are slightly higher than the Sa values, the Sq values also fall within the same ranges just described for the Sa values.

The Surface Kurtosis, Sku, describes the “peakedness” of the surface topography, and is defined as:

$${S}_{ku} = \frac{1}{MN {S}_{q}^{4}} {\sum }_{k = 0}^{M - 1} {\sum }_{l = 0}^{N - 1} {[ z ( {x}_{k} , {y}_{l} ) ]}^{4} \qquad R4$$

| Sample/Example | Sku |
|---|---|
| Sample 2 | 2.424 |
| Sample 3 | 2.796 |
| Sample 4 | 2.565 |
| Sample 1 | 2.490 |
| Comparative Example D | 2.390 |
| Comparative Example B | 1.924 |
| Comparative Example A | 1.786 |

Notably Samples 1-4 have a Sku greater than Comparative Examples A, B, and D. In some embodiments, the Sku is greater than 2.40, 2.45, 2.50, 2.55, 2.60, 2.65, 2.70, or 2.75. In some embodiments, the Sku is less than 3.00, 2.95, 2.90, 2.85, 2.80, 2.75, 2.70, 2.65, 2.60 or 2.55, or 2.50, or 2.45.

The Surface Bearing Index, Sbi, is defined as:

$${S}_{bi} = \frac{{S}_{q}}{{Z}_{0.05}} ,$$

wherein Z_{0.05} is the surface height at 5% bearing area.

The Valley Fluid Retention Index, Svi, is defined as:

$${S}_{vi} = \frac{{V}_{v} ( {h}_{0.8} )}{( M - 1 ) ( N - 1 ) δ x δ y} / {S}_{q} ,$$

wherein Vv(h0.80) is the void volume at valley zone within 80-100% bearing area.

As noted in the S Parameters table above, the Sbi/Svi ratio of the comparative smooth samples were 1 and 3. The microstructured surfaces having improved microorganism removal after cleaning had a Sbi/Svi ratio of 3 or greater than 3. The microstructured surfaces have a Sbi/Svi ratio of at least 4, 5, or 6. In some embodiments, the microstructured surfaces having improved microorganism removal after cleaning had a Sbi/Svi ratio of at least 7, 8, 9, or 10. In some embodiments, the microstructured surfaces having improved microorganism removal after cleaning had a Sbi/Svi ratio of at least 15, 20, 25, 30, 35, 40 or 45. The microstructured surfaces having improved microorganism removal after cleaning had a Sbi/Svi ratio of less than the comparative square wave microstructured surfaces. Thus, the microstructured surfaces having improved microorganism removal after cleaning had a Sbi/Svi ratio of less than 90, 85, 80, 75, 70 or 65. In some embodiments, the microstructured surfaces having improved microorganism removal after cleaning had a Sbi/Svi ratio of less than 60, 55, 50, 45, 40, 35, 30, 25, 20, or 10.

Topography maps can also be used to measure other features of the microstructured surface. For example, the peak height (especially of a repeating peak of the same height) can be determined from the height histogram function of the software. To calculate the percentage of “flat regions” of a square wave film, the “flat regions” can be identified using SPIP's Particle Pore Analysis feature, which identifies certain shapes (in this case, the “flat tops” of the microstructured square wave film.

The surface described herein is surmised to be a new engineered surface (i.e., not naturally occurring) e.g., comprising utilitarian discontinuities, regardless of the dimensions of the structures of the surface. In one embodiment, the surface may be a (e.g., decorative) macrostructured surface. A macro structured surface is typically visible without magnification by a microscope. In some embodiments, the average width of a macrostructure is at least 2, 3, 4, 5, 6, 7, 8, 9, or 10 mm. The average length of a macrostructure can be in the same range as the average width or can be significantly greater than the width. For example, when the macrostructure is a wood-grain macrostructure as commonly found on a door, the length of the macrostructure can extend the entire length of the (e.g., door) article. The height of the macrostructure is typically less than the width. In some embodiments, the height is less than 5, 4, 3, 2, 1, or 0.5 mm.

In other embodiments, the surface described herein as a microstructured surface. A microstructured surface comprises at least one (e.g., width or height) and typically at least two (e.g., width and height) have a dimension up to 1 mm.

In some embodiments, the microstructured surfaces comprising microstructures wherein the maximum width of the valleys is at least 1, 2, 3, or 4 microns and more typically greater than 5, 6, 7, 8, 9, or 10 microns ranging up to 250 microns. In some embodiments, the maximum width of the valleys is at least 11, 12, 13, 14, 15, 16, 17, 18, 19, 20, 21, 22, 23, 24, or 25 microns. In some embodiments, the maximum width of the valleys is at least 30, 35, 40, 45, or 50 microns. In some embodiments, the maximum width of the valleys is greater than 50 microns. In some embodiments, the maximum width of the valleys is at least 55, 60, 65, 70, 75, 85, 85, 90, 95 or 100 microns. In some embodiments, the maximum width of the valleys is at least 125, 150, 175, 200, 225, or 250 microns. Larger valley widths may better accommodate the removal of dirt. In some embodiments, the maximum width of the valleys is no greater than 1000, 950, 900, 850, 800, 750, 700, 650, 600, 550, 500, 450, 400, 350, 300, 250, 225, 200, 175, 150, 125, 100, 75, or 50 microns. In some embodiments, the maximum width of the valleys is no greater than 45, 40, 35, 30, 25, 20, or 15 microns. It is appreciated that the microstructured surface would be beneficial even when some of the valleys are less than the maximum width. For example, if half of the total number of valleys of the microstructured surface are within the desired range, about half the benefit may be obtained. Thus, in some embodiments, less than 50, 45, 40, 35, 30, 25, 20, 15, 10, 5 or 1% of the valleys have a maximum width of less than 10, 9, 8, 7, 6, or 5 microns. Alternatively at least 50, 60, 70, 80, 90, 95 or 99% of the valleys have a maximum width, as described above. In some embodiments, such as when microstructured surface comprises valleys having different widths, the minimum and average width may fall within the dimensions just described.

In typical embodiments, the dimensions of the microstructures fall within the same ranges as described for the valleys. In other embodiments, the width of the valleys can be greater than the width of the microstructures.

The height of the microstructures (e.g., peaks) is within the same range as the maximum width of the valleys as previously described. In some embodiments, the peak structures typically have a height (H) ranging from 1 to 125 microns. In some embodiments, the height of the microstructures is at least 2, 3, 4, or 5 microns. In some embodiments, the height of the microstructures is at least 6, 7, 8, 9 or 10 microns. In some embodiments, the height of the microstructures no greater than 100, 90, 80, 70, 60, or 50 microns. In some embodiments, the height of the microstructures is no greater than 45, 40, 35, 30 or 25 microns. In some embodiments, the height of the microstructures is no greater than 24, 23, 22, 21, 20, 19, 18, 17, 16, 15, 14, 13, 12, 11, or 10 microns. In typical embodiments, the height of the valley or channel is within the same range as just described for the peak structures. In some embodiments, the peak structures and valleys have the same height. In other embodiments, the peak structures can vary in height. For example, when the microstructured surface is disposed on a macrostructured or microstructured surface, rather than a planar surface. When the peaks vary in height, the height of the peaks can be expressed as an average peak height. Thus, the average peak height may fall with the height criteria just described.

The aspect ratio of the valley is the height of the valley (which can be the same as the peak height of the microstructure) divided by the maximum width of the valley. In some embodiments the aspect ratio of the valley is at least 0.1, 0.15, 0.2, or 0.25. In some embodiments, the aspect ratio of the valley is no greater than 1, 0.9, 0.8, 0.7, 0.6 or 0.5. Thus, in some embodiments, the height of the valley is typically no greater than the maximum width of the valley, and more typically less than the maximum width of the valley.

The base of each microstructure may comprise various cross-sectional shapes including but not limited to parallelograms with optionally rounded corners, rectangles, squares, circles, half-circles, half-ellipses, triangles, trapezoids, other polygons (e.g., pentagons, hexagons, octagons, etc., and combinations thereof.

Useful (optional) base member materials include, for example, styrene-acrylonitrile, cellulose acetate butyrate, cellulose acetate propionate, cellulose triacetate, polyether sulfone, polymethyl methacrylate, polyurethane, polyester, polycarbonate, polyvinyl chloride, polystyrene, polyethylene naphthalate, copolymers or blends based on naphthalene dicarboxylic acids, polycyclo-olefins, polyimides, silicone and fluorinated films, and glass. Optionally, the base material can contain mixtures or combinations of these materials. In an embodiment, the base may be multi-layered or may contain a dispersed component suspended or dispersed in a continuous phase. An example of useful PET films includes photograde polyethylene terephthalate and MELINEX™ PET available from DuPont Films of Wilmington, Del. An example of a useful thermoformable material is polyethylene terephthalate (polyester with glycol) commercially available as VIVAK PETG. Such material is characterized by having a tensile strength ranging from 5000-10,000 psi (ASTM D638) and a flexural strength of 5,000 to 15,000 (ASTM D-790). Such material has a glass transition temperature of 178° F. (ASTM D-3418).

Referring again to FIGS. 2-4 and 6, the presently microstructured (e.g., tooling) film optionally comprises an (e.g., engineered) microstructured surface (200, 300, 400, 600) disposed on abase member (210, 310, 410, 610). In some cases, the base member is planar (e.g., parallel to reference plane 126). The thickness of the base member is typically at least 10, 15, 20, or 25 microns (1 mil) and typically no greater than 500 microns (20 mil) thickness. In some embodiments, the thickness of the base member is no greater than 400, 300, 200, or 100 microns. The width of the (e.g., film) base member may be is at least 30 inches (122 cm) and preferably at least 48 inches (76 cm). The base member may be continuous in its length for up to about 50 yards (45.5 m) to 100 yards (91 m) such that the microstructured film is provided in a conveniently handled roll-good. Alternatively, however, the (e.g., film) base member may be individual sheets or strips rather than as a roll-good.

Thermoformable microstructured base members typically having a thickness of at least 50, 100, 200, 300, 400, or 500 microns. Thermoformable microstructured base members may have thickness up to 3, 4, or 5 mm or greater. The base member can, in some implementations, include discrete pores and/or pores in communication. The thickness of the base member can vary depending on the use.

The organic polymeric materials of the base member can be the same organic polymeric materials previously described for the microstructured surface. In addition, fiber- and/or particle-reinforced polymers can also be used.

Non-limiting examples of suitable non-biodegradable polymers for base members include polyolefins (e.g., polyisobutylene copolymers), styrenic block copolymers (e.g., styrene-isobutylene-styrene block copolymers, such as styrene-isobutylene-styrene tert-block copolymers (SIBS); polyvinylpyrrolidone; polyvinyl alcohols; copolymers of vinyl monomers such as EVA; polyvinyl ethers; polyvinyl aromatics; polyethylene oxides; polyesters such as polyethylene terephthalate; polyamides; polyacrylamides; polyethers such as polyether sulfone; polyolefins such as polypropylene, polyethylene, and high or ultra high molecular weight polyethylene; polyurethanes; polycarbonates; silicones; siloxane polymers; natural based polymers such as optionally modified polysaccharides and proteins including, but not limited to, cellulosic polymers and cellulose esters such as cellulose acetate; and combinations comprising at least one of the foregoing polymers. Combinations may include miscible and immiscible blends as well as laminates.

The base member may be comprised of a biodegradable material. Non-limiting examples of suitable biodegradable polymers include polycarboxylic acid; polyanhydrides such as maleic anhydride polymers; polyorthoesters; poly-amino acids; polyethylene oxide; polyphosphazenes; polylactic acid, polyglycolic acid, and copolymers and mixtures thereof such as poly(L-lactic acid) (PLLA), poly(D,L,-lactide), poly(lactic acid-co-glycolic acid), and 50/50 weight ratio (D,L-lactide-co-glycolide); polydioxanone; polypropylene fumarate; polydepsipeptides; polycaprolactone and co-polymers and mixtures thereof such as poly(D,L-lactide-co-caprolactone) and polycaprolactone co-butylacrylate; polyhydroxybutyrate valerate and mixtures thereof; polycarbonates such as tyrosine-derived polycarbonates and arylates, polyiminocarbonates, and polydimethyltrimethylcarbonates; cyanoacrylate; calcium phosphates; polyglycosaminoglycans; macromolecules such as polysaccharides (including hyaluronic acid, cellulose, and hydroxypropylmethyl cellulose; gelatin; starches; dextrans; and alginates and derivatives thereof, proteins and polypeptides; and mixtures and copolymers of any of the foregoing. The biodegradable polymer can also be a surface erodible polymer such as polyhydroxybutyrate and its copolymers, polycaprolactone, polyanhydrides (both crystalline and amorphous), and maleic anhydride.

It also is possible and often preferable in order to maintain the fidelity of the microstructures to include a surface energy modifying compound in the composition used to form the microstructures. In some embodiments, the bloom additive may retard or prevent crystallization of the base composition. Suitable bloom additives may be found, for example, in International Publication No. WO 2009/152345 (Scholz et al.) and U.S. Pat. No. 7,879,746 (Klun et al.).

The materials for retroreflective sheeting and brightness enhancing films have been chosen based on the optical properties. Thus, the peak structures and adjacent valleys typically comprise a material having a refractive index of at least 1.50, 1.55, 1.60 or greater. Further, the transmission of visible light is typically greater than 85 or 90%. However, optical properties may not be of concern for many embodiments of the presently described films, methods, and articles. Thus, various other materials may be used having a lower refractive index including colored, light transmissive, and opaque.

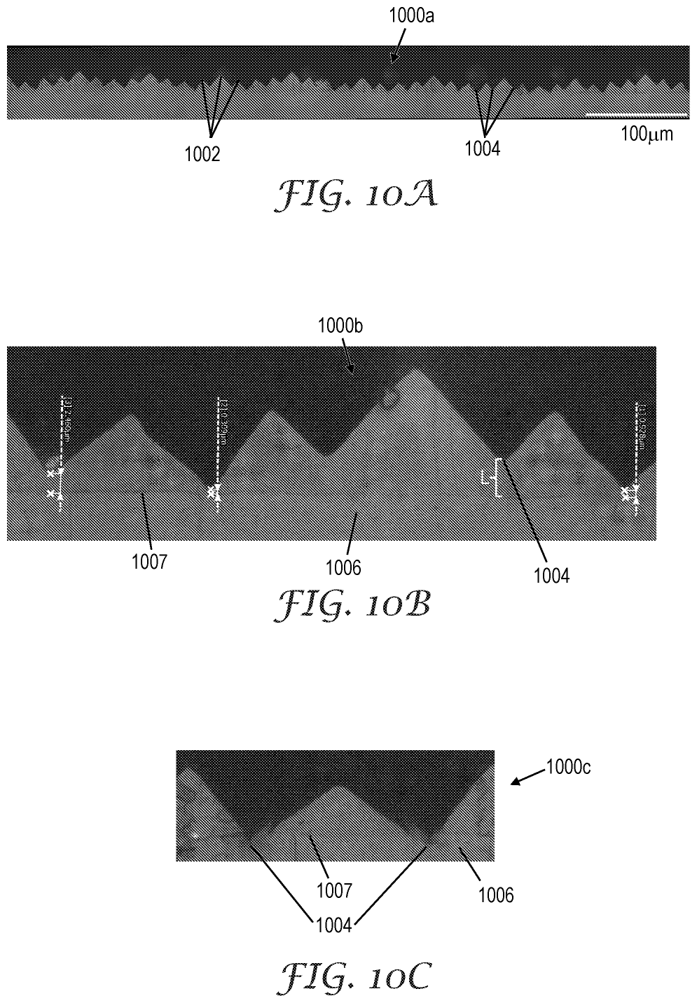

Referring to FIG. 10A, a scanning electron microscopy (SEM) image is provided of a cross-section of an exemplary microstructured (e.g., tooling) film 1000a. The microstructured film 1000a was prepared as described in Example 3 below, including a 5 mil (127 micron) thick PETG substrate and includes a plurality of peaks 1002 and valleys 1004. The peaks 1002 and valleys 1004 are configured to essentially be an inverse of the peaks and valleys of a microstructured surface of utilitarian discontinuities of the microstructured surface of microstructured articles according to the present disclosure. By “essentially” being an inverse, it is understood that due to the microstructured surface of microstructured articles being located at least partially on a curved surface of an article, the microstructured surface will not be identically inverse to a planar microstructured (tooling) film. Rather, for instance, some angles between adjacent peaks may be different when located on a curve than when located on a flat base.

Referring to FIG. 10B, an SEM image of a cross-section of the microstructured tooling film also shown in FIG. 10A, there may be a land material present between the bottom of at least some of the channels or valleys 1004 and a top surface 1007 of a (e.g., planar) base member 1006, each having a thickness L. Three different land material thicknesses were measured on the sample in FIG. 10B, having a thickness of 1: 0.928 microns; 2: 0.309 microns; and 3: 2.460 microns. In some embodiments, such as when the microstructured surface is prepared from casting and curing a polymerizable resin composition, the thickness of the land material is typically a minimum of at least 0.1, 0.2, 0.3, 0.4, 0.5, 0.6, 0.7 0.8, 1, 2, 3, 4, or 5 microns ranging up to 50 microns. In some embodiments, the thickness of the land material is a maximum of no greater than 45, 40, 35, 30, 25, 20, 15, 10, 9, 8, 7, 6, 5, 4, 3, 2, 1, 0.9, 0.8, 0.7, 0.6, 0.5, 0.4, 0.3, or 0.2 microns. It was unexpectedly found that in some cases, a maximum land thickness of 0.5 microns or less contributed to a microstructured film that is more resistant to macrocracks when thermoformed than the same microstructured film having a maximum land thickness of greater than 0.5 microns. Referring to FIG. 10C, an SEM image of a cross-section of another portion of the microstructured tooling film of FIG. 10A, in some cases at least some of the valleys 1004 are present in the base member 1006 (i.e., below the top surface 1007), thus having no land material thickness at those locations.

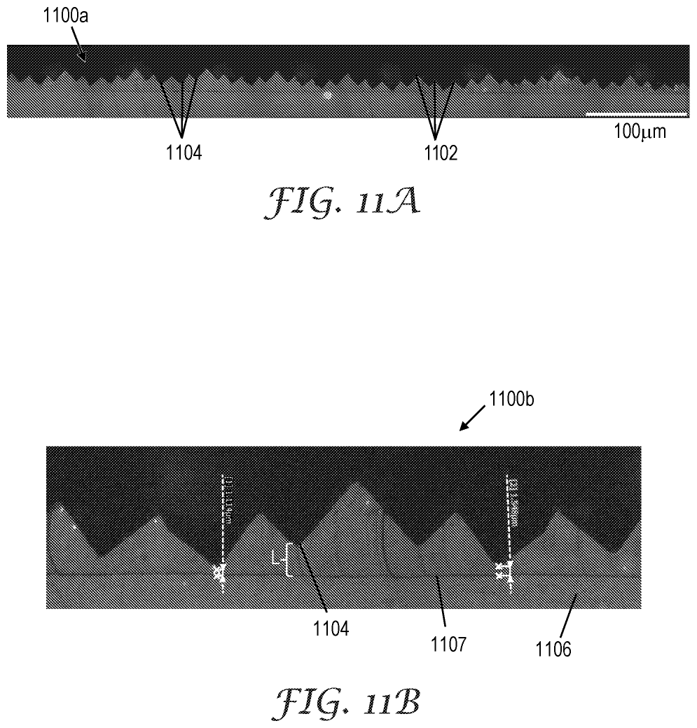

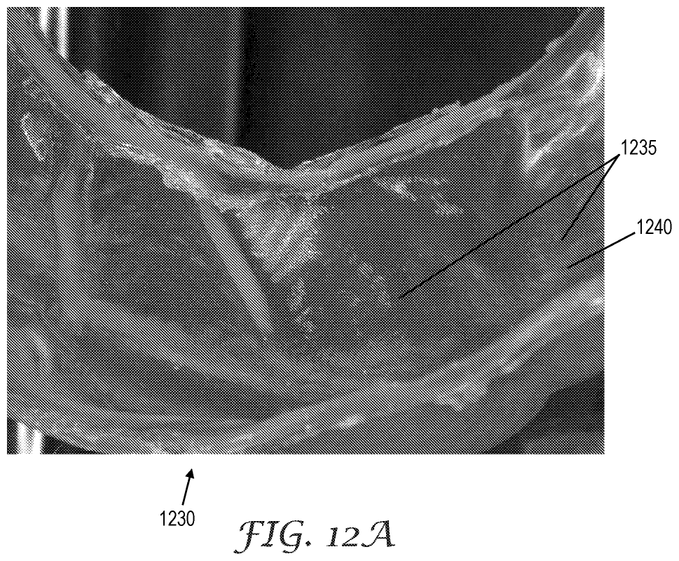

Referring to FIGS. 11A-B, SEM images are provided of cross-sections of portions of a microstructured tooling film 1100a and 1100b, respectively. The microstructured films 1100a and 1100b were prepared as described in Comparative Example 2 below, including a 5 mil (127 micron) thick PETG substrate and include a plurality of peaks 1102 and valleys 1104. Two different land material thicknesses were measured on the sample in FIG. 10B, having a thickness of 1: 1.114 microns and 2: 1.548 microns.

The presently described microstructured surface does not prevent microorgansims (e.g., bacteria such as Streptococcus mutans, Staphyloccus aureus, or Psueodomonas aeruginosa) from being present on the microstructured surface, or in other words, does not prevent biofilm from forming. However, such microstructured surfaces have been demonstrated to be easier to clean, providing a low amount of microorganism (e.g., bacteria) present after cleaning. Without intending to be bound by theory, scanning electron microscopy images suggest that large continuous biofilms typically form on a smooth surface. However, even though the peaks and valleys are much larger than the microorganism (e.g., bacteria), the biofilm is interrupted by the microstructured surface. In some embodiments, the biofilm (before cleaning) is present as discontinuous aggregate and small groups of cells on the microstructured surface, rather than a continuous biofilm. After cleaning, biofilm aggregates in small patches cover the smooth surface. However, the microstructured surface was observed to have only small groups of cells and individual cells after cleaning. In favored embodiments, the microstructured surface provides a log 10 reduction of microorganism (e.g., bacteria such as Streptococcus mutans, Staphyloccus aureus, or Psueodomonas aeruginosa) of at least 2, 3, 4, 5, 6, 7 or 8 after cleaning. In some embodiments, the microstructured surface has a mean log 10 of recovered colony forming units of microorganism of less than 6, 5, 4, or 3 after cleaning for a highly contaminated surface.

In some embodiments, the microstructured surface can prevent an aqueous or (e.g., isopropanol) alcohol-based cleaning solution from beading up as compared to a smooth surface comprised of the same polymeric material. When a cleaning solution beads up or in other words dewets, the disinfectant agent may not be in contact with a microorganism for a sufficient duration of time to kill the microorganism. However, it has been found that at least 50, 60, 70, 80, or 90% of the microstructured surface can comprise cleaning solution 1, 2, and 3 minutes after applying the cleaning solution to the microstructured surface.

When the facets of the microstructures are joined such that the apex and valleys are sharp or rounded, but not truncated, the microstructured surface can be characterized are being free of flat surfaces, that are parallel to the planar base layer. However, wherein the apex and/or valleys are truncated, the microstructured surface typically comprises less than 50, 45, 40, 35, 30, 25, 20, 15, 10, 5 or 1% of flat surface area that is substantially parallel to the planar base layer. In one embodiment, the valleys may have flat surfaces and only one of the side walls of the peaks is angled. However, in favored embodiments, both side walls of adjacent peaks defining the valley(s) are angled toward each other, as previously depicted. Thus, the side walls on either side of a valley are not parallel to each other.

The facets of adjacent peak structures are typically connected at the bottom of the valley, i.e., proximate the planar base layer. The facets of the peak structures form a continuous surface in the same direction.

Referring now to FIG. 8A, a generalized schematic perspective view is provided of a tool 820 comprising a plurality of protrusions, namely a tool 820 having a shape of a dental arch in which numerous protrusions are present; e.g., each tooth 825, as well as the overall curved arch shape. Moreover, the tool 820 further includes one or more areas having a concave shape e.g., concavities 827 of some of the teeth. The presence of a concavity will result in an outwardly curved inverse shape on the thermoformed article. This is a case of a tool having a plurality of protrusions and a plurality of concavities. Any tool according to the present disclosure may include one or more protrusions, one or more concavities, or at least one of each of a protrusion and a concavity.

In methods of the present disclosure, a microstructured film is disposed on some or all of a tool, including on one or more protrusions or one or more concavities. For example, FIG. 8B is a photograph of a microstructured (e.g., tooling) film 800 of Example 1 disposed on a dental arch 820, with the microstructured surface 810 on the exterior of the film 800. As mentioned above, an advantage of this configuration is that a standard microstructured surface can be imparted to a custom tool. The microstructured film 800 in combination with the dental arch 820 form a (e.g., microstructured) tooling article 860. In this case, the microstructured film 800 has been thermoformed onto the dental arch 820 to conform to protrusions and concavities of the dental arch 820. Depending on the specific application, the microstructured film may be disposed on 50% or greater of a thermoforming surface of the tool, such as 55%, 60%, 65%, 70%, 75%, 80%, 85%, 90%, or 95% or greater of a thermoforming surface of the tool; and 100% or less, 98%, 93%, 88%, 83%, 78%, 73%, 68%, 63%, 58%, or 53% or less of a thermoforming surface of the tool.

FIG. 8C is a photograph of an exemplary article 830 of Example 2 thermoformed onto the microstructured (e.g., tooling) film (not visible under the article 830) and dental arch 820 of FIG. 8B. In this example, the thermoplastic polypropylene polymer is shaped to comprise more than one curve that comprises a microstructured surface, namely each curve that is an inverse of a protruding portion of a tooth, a concavity of a tooth, and the curve of the dental arch. As such, depending on the specific microstructured article being formed, the thermoplastic polymer may suitably be shaped to comprise a second curve that comprises a microstructured surface, a third curve, a fourth curve, etc.

By thermoforming a thermoplastic polymer onto the microstructured film 800 present on the dental arch 820, an exemplary microstructured article 830 was formed having a microstructured surface on an interior portion of (at least one) curve of the microstructured article 830.

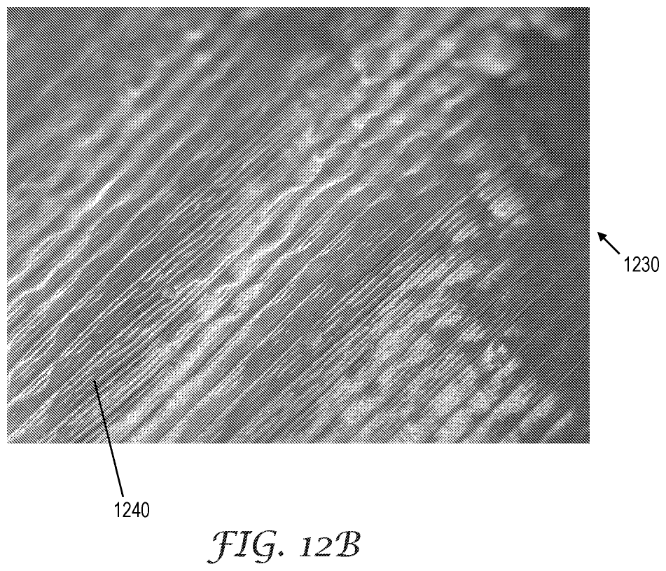

For instance, FIG. 12A is an optical micrograph image of an interior surface of the exemplary article 1230, wherein the surface is a microstructured surface 1240 located on a plurality of curves 1235 of the microstructured article 1230. FIG. 12B provides a closer view of the microstructured surface 1240, which lacks macrocracks. While in this example a portion of a curve comprising the microstructured surface comprises an interior portion of the article, in certain articles according to the present disclosure a portion of a curve comprising the microstructured surface comprises an exterior portion of the article (e.g., a handle of a utensil or tool, a vehicle steering wheel, etc.).

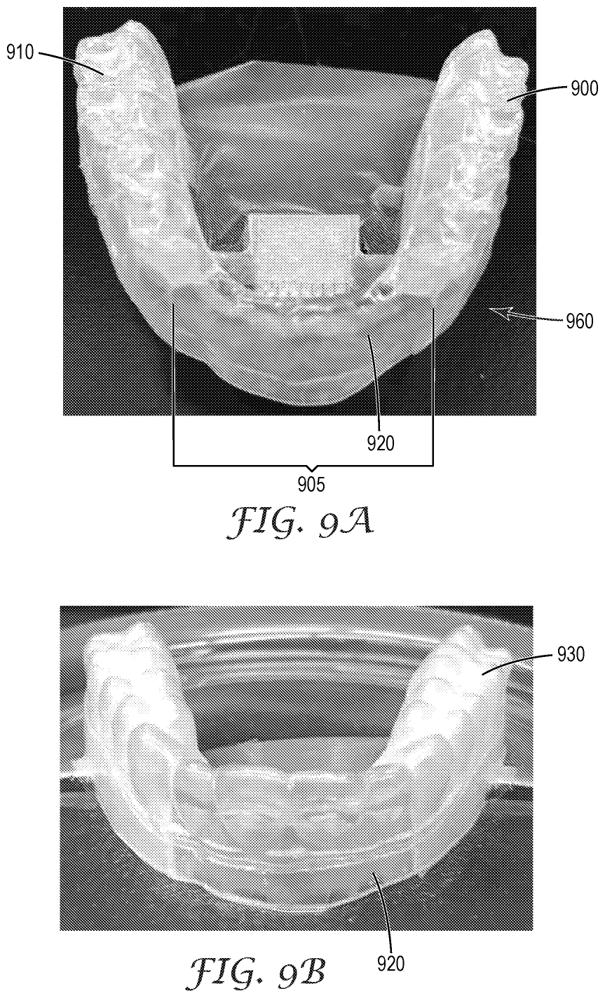

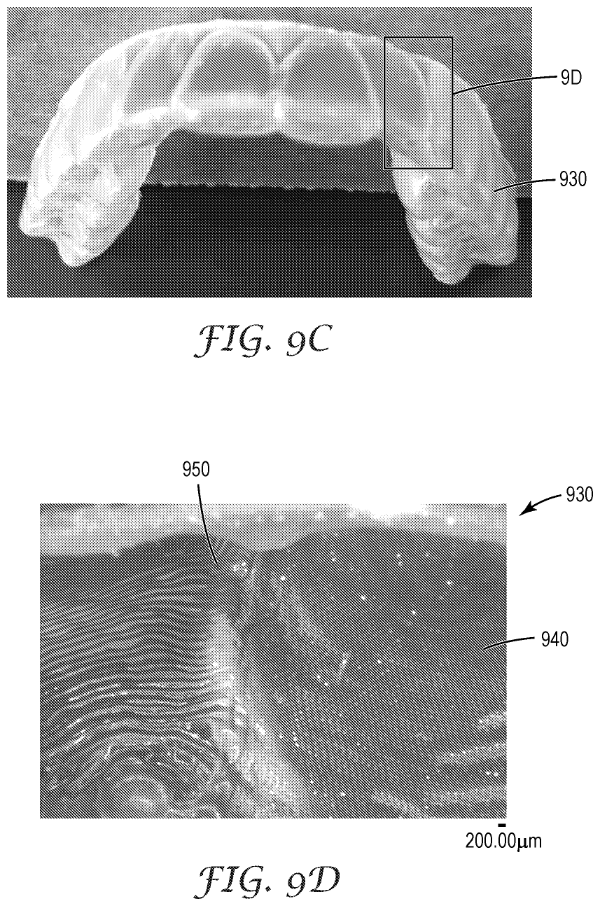

An advantage of adding a microstructured film to a tool having one or more protrusions and/or concavities is that it is a straightforward option to dispose the microstructured film on only select portions of the tool. For instance, FIG. 9A is a photograph of a polyvinyl chloride microstructured film 900 disposed on a dental arch, in which a portion of the microstructured (e.g., tooling) film 900 has been removed in the incisor area 905 of the dental arch 920. The microstructured surface 910 is present on the exterior of the film 900. Thus, a portion of the microstructured film may optionally be removed from the thermoforming surface of the tool prior to step c). Including a microstructured film on only a portion of a thermoforming surface of the tool (i.e., less than the full surface) of a tool can be useful when it is desired to provide a first coefficient of friction by the interior microstructured surface of the curve of that is different (i.e., either higher or lower) than a second coefficient of friction of a curve of the article that lacks the microstructured surface. Accordingly, in select embodiments, the thermoplastic polymer of an exemplary microstructured article is shaped to comprise a second curve that lacks a microstructured surface.

FIG. 9B is a photograph of an article 930 thermoformed onto the microstructured film 900 and dental arch 920 of FIG. 9A. The microstructured film 900 used here has utilitarian discontinuities that are different from the peaks and valleys of the present disclosure. The peaks and valleys of the microstructured film 900 have a cube corner structure and are described in detail in application No. 63/243,855 (Docket 84055US002). However, the principles of how the microstructured film 900 is used applies to the specific microstructured films described herein. The polypropylene microstructured article 930 covers both portions of the dental arch 920 where the microstructured (e.g., tooling) film 900 was disposed and portions in the incisor area 905 where the microstructured film 900 had been removed. In such embodiments, a geometry of a tool can advantageously be configured to be smaller (e.g., compensated) in a location where the microstructured film is disposed than in a location where the microstructured film is not disposed, such that the resulting microstructured article has an overall desired size that is not significantly affected by where the microstructured film is located on the tool. FIG. 9C is a photograph of the article 930 of FIG. 9B after removal of the article 930 from the dental arch 920. In general, the front (e.g., incisor) area of the tray article 930, which lacks the microstructured surface on its interior surface, has a more transparent appearance than the rest of the interior surfaces of the tray article 930. The box 9D indicates a portion of the microstructured article 930 shown in FIG. 9D. In particular, FIG. 9D is an optical micrograph image of a portion of the interior surface of the article 930 showing differentially microstructured areas between the location of the microstructured film and where a portion of the microstructured film had been removed from the dental arch. The microstructured surface 940 is present where the thermoplastic polymer was thermoformed over the microstructured film 900 and a surface 950 lacking utilitarian discontinuities is present where the thermoplastic polymer was thermoformed directly on the tool 920. In this case, the tool 920 was formed by an additive manufacturing method, and the surface 950 has a surface roughness imparted by the variations in surface caused by limitations in the resolution of the particular additive manufacturing method.

In some embodiments, the microstructured surface (e.g., at least peak structures thereof) comprise an organic polymeric material with a glass transition temperature (as measured with Differential Scanning Calorimetry) of at least 25° C. In some embodiments, the organic polymeric material has a glass transition temperature of at least 30, 35, 40, 45, 50, 55 or 60° C. In some embodiments, the organic polymeric material has a glass transition temperature no greater than 100, 95, 90, 85, 80, or 75° C.

In some embodiments, the microstructured surface (e.g., at least peak structures thereof) comprise a reaction product of a composition comprising: a monomer having a Tg of no greater than 0° C., a monomer having a Tg of greater than 0° C., a polar monomer, polyvinyl butyral (PBV), and a crosslinker. Further details of suitable monomers for such compositions may be found, for instance, in PCT Publication No. WO 2022/123440 (Johnston et al.), incorporated herein by reference in its entirety.

In a third aspect, a tooling article is provided. The tooling article comprises:
a) a tool shaped to comprise at least one of a protrusion or a concavity; and
b) a microstructured film disposed on at least a portion of the tool including the protrusion and/or the concavity, wherein the microstructured film comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

FIG. 8B depicts a microstructured tooling film disposed on a dental arch. As mentioned above, FIG. 8B is a photograph of the microstructured (e.g., tooling) film of Example 1 disposed on a dental arch 820, with the microstructured surface 810 on the exterior of the film 800. In this case, the microstructured film 800 has been thermoformed onto the dental arch 820 to conform to protrusions and concavities of the dental arch 820. As such, an exemplary tooling article 860 comprises a tool (e.g., having a shape of a dental arch) 820 shaped to comprise at least one of a protrusion or a concavity, and a microstructured film 800 disposed on at least a portion of the tool 820 including the protrusion and/or the concavity, wherein the microstructured film comprises peak structures and adjacent valleys 810 having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees. In certain such embodiments, the microstructured film 800 is disposed on 90% or greater of a thermoforming surface of the tool 820.

Further as mentioned above, FIG. 9A is a photograph of a polyvinyl chloride microstructured film 900 disposed on a dental arch, in which a portion of the microstructured (e.g., tooling) film 900 has been removed in the incisor area 905 of the dental arch 920. The microstructured surface 910 is present on the exterior of the film 900. Similar to FIG. 8C, FIG. 9A shows a tooling article 960 comprising a tool (e.g., having a shape of a dental arch) 920 shaped to comprise at least one of a protrusion or a concavity, and a microstructured film 900 disposed on at least a portion of the tool 920 including the protrusion and/or the concavity. In such an embodiment, the microstructured film 900 is disposed on only a portion of a thermoforming surface of the tool 920.

### Thermoplastic Polymers

Suitable thermoplastic polymers for use in making the microstructured article comprise a material that exhibits a draw down ratio of greater than 1.1, such as 1.2 or more, 1.3, 1.4, 1.5, 1.6, 1.7, 1.8, 1.9, 2.0 2.1, 2.2, or 2.3 or more; and 3.0 or less, 2.9, 2.8, 2.7, 2.6, 2.5, or 2.4 or less. Optionally, suitable thermoplastic polymers comprise a material that exhibits an elongation at break of 50% or greater, such as 55% or greater, 60%, 65%, 70%, 75%, 80%, 85%, 90%, 95%, or 100% or greater; and 400% or less. Elongation at break can be determined by ASTM D638-10, using test specimen Type V. It is preferred that the thermoplastic polymers possess the following properties: having thermal transition points such as glass transition temperatures between 70° C. and 140° C., an elongation at break greater than 100%, stain resistance, crack resistance, resistance to stress relaxation, and good optical clarity.

Some example suitable thermoplastic polymers include for instance and without limitation, a polypropylene, a polyester, a co-polyester, a polycarbonate, a thermoplastic polyurethane, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, silicone urethane copolymer, fluoropolymer, a thermoplastic elastomer, or any combination thereof. Polyurethanes may be formed from aromatic or aliphatic isocyanates combined with polyester or polyether polyols or a combination thereof. In some favored embodiments, the thermoplastic polymer comprises a polypropylene, such as under the trade designation “INVISACRYL C” from Great Lakes Dental Technologies (Tonawanda, NY).

Suitable polyesters include, but are not limited to, copolyesters available under the trade designation TRITAN from Eastman Chemical, Kingsport, TN, polyethylene terephthalate (PET), polyethylene terephthalate glycol (PETg), polycyclohexylenedimethylene terephthalate (PCT), polycyclohexylenedimethylene terephthalate glycol (PCTg), polycarbonate (PC), and mixtures and combinations thereof. Suitable PETg and PCTg resins can be obtained from various commercial suppliers such as, for example, Eastman Chemical, Kingsport, TN; SK Chemicals, Irvine, CA; DowDuPont, Midland, MI; Pacur, Oshkosh, WI; and Scheu Dental Tech, Iserlohn, Germany. For example, EASTAR GN071 PETg resins and PCTg VM318 resins from Eastman Chemical have been found to be suitable. Suitable polypropylene or polypropylene copolymer include, but are not limited to, Essix C+ from Dentsply Sirona, Charlotte, NC, and HardCast Material and INVISACRYL C from Great Lakes Dental Technologies, Tonawanda, NY. A suitable thermoplastic elastomer includes Hytrel from DuPont, Wilmington DE, Riteflex from Celanese, Irving, TX, Ecdel from Eastman Chemical Company, Kingsport, TN, Arnitel from DSM, Heerlen, Netherlands, Pelprene from Toyobo Co, Ltd, Osaka, Japan, and Elitel from Unitaka, Osaka, Japan.

### Optional Additives & Coatings

The thermoplastic polymer material of the microstructured article may contain other additives such as antimicrobial agents (including antiseptics and antibiotics), dyes, mold release agents, antioxidants, plasticizers, thermal and light stabilizers including ultraviolet (UV) absorbers, fillers, (e.g., for certain applications the fillers are radioopaque), pigments, and the like.

Suitable antimicrobials can be incorporated into or deposited onto the polymers. Suitable preferred antimicrobials include those described in US Publication Nos. 2005/0089539 and 2006/0051384 to Scholz et al. and US Publication Nos. 2006/0052452 and 2006/0051385 to Scholz. The microstructures of articles of the present disclosure also may be coated with antimicrobial coatings such as those disclosed in International Application No. PCT/US2011/37966 to Ali et al.

Typically, the microstructured surface is not prepared from a low surface energy material (e.g., a fluoropolymer or PDMS) and does not comprise a low surface energy coating, a material or coating that on a flat surface has a receding contact angle with water of greater than 90, 95, 100, 105, or 110 degrees. In this embodiment, the low surface energy of the material is not contributing to the cleanability. Rather, the improvement in cleaning is attributed to the features of the microstructured surface. In this embodiment, the microstructured surface is prepared from a material such that a flat surface of the material typically has a receding contact angle with water of less than 90, 85, or 80 degrees.

Optionally, a low surface energy coating may be applied to the microstructures. Exemplary low surface energy coating materials that may be used include materials such as hexafluoropropylene oxide (HFPO), or organosilanes such as, alkylsilane, alkoxysilane, acrylsilanes, polyhedral oligomeric silsequioxane (POSS) and fluorine-containing organosilanes, just to name a few. Examples of particular coatings known in the art may be found, e.g., in US Publication No. 2008/0090010 (Zhang et al.), and commonly owned publication, US Publication No. 2007/0298216 (Jing et al.). For embodiments, that include a coating is applied to the microstructures, it may be applied by any appropriate coating method, such as sputtering, vapor deposition, spin coating, dip coating, roll-to-roll coating, or any other number of suitable methods.

In some embodiments, the microstructures or microstructured surface may be modified such that the microstructured surface is more hydrophilic. The microstructured surface generally may be modified such that a flat organic polymer film surface of the same material as the modified microstructured surface exhibits an advancing or receding contact angle of 45 degrees or less with deionized water. In the absence of such modifications, a flat organic polymer film surface of the same material as the microstructured surface typically exhibits an advancing or receding contact angle of greater than 45, 50, 55, or 60 degrees with deionized water.

Any suitable known method may be utilized to achieve a hydrophilic microstructured surface. Surface treatments may be employed such as plasma treatment, vacuum deposition, polymerization of hydrophilic monomers, grafting hydrophilic moieties onto the film surface, corona or flame treatment, etc. For certain embodiments, the hydrophilic surface treatment comprises a zwitterionic silane, and for certain embodiments, the hydrophilic surface treatment comprises a non-zwitterionic silane. Non-zwitterionic silanes include a non-zwitterionic anionic silane, for instance.

In other embodiments, the hydrophilic surface treatment further comprises at least one silicate, for example and without limitation, comprising lithium silicate, sodium silicate, potassium silicate, silica, tetraethylorthosilicate, poly(diethoxysiloxane), or a combination thereof. One or more silicates may be mixed into a solution containing the hydrophilic silane compounds, for application to the microstructured surface.

### Articles

Since one useful object is to provide an article having a surface with increased microorganism (e.g., bacteria) removal when cleaned, the article is typically not a (e.g., sterile) medical article such as nasal gastric tubes, wound contact layers, blood stream catheters, stents, pacemaker shells, heart valves, orthopedic implants such as hips, knees, shoulders, etc., periodontal implants, dentures, dental crowns, contact lenses, intraocular lenses, soft tissue implants (breast implants, penile implants, facial and hand implants, etc.), surgical tools, sutures including degradable sutures, cochlear implants, tympanoplasty tubes, shunts including shunts for hydrocephalus, post-surgical drain tubes and drain devices, urinary catheters, endotraecheal tubes, heart valves, wound dressings, other implantable devices, and other indwelling devices. The medical articles just described may be characterized as single use articles, i.e., the article is used once and then discarded. The above articles may also be characterized as single person (e.g., patient) articles. Thus, such articles are typically not cleaned (rather than sterilized) and reused with other patients.

In contrast, the articles and surfaces described herein include those where the microstructured surface is exposed to the surrounding (e.g., indoor or outdoor) environment and is subject to being touched or otherwise coming in contact with multiple people and/or animals, as well as other contaminants (e.g., dirt).

In some embodiments, the microstructured surface of the article, comes in direct (e.g., skin) contact with (e.g., multiple) people and/or animals during normal use of the article. In other embodiments, the microstructured surface may come is close proximity to (e.g., multiple) people/or animals in the absence of direct (e.g., skin) contact. However, since the microstructured surface comes in close proximity such article surfaces can easily be contaminated with microorganisms (e.g., bacteria) and are therefore cleaned to prevent the spreading of microorganisms to others.

Representative articles that would be cleaned during normal use and/or are amenable for use integrating the microstructured surface into a curved surface of the article include various interior or exterior surfaces or components of a medical article, a dental article, an orthodontic article, a vehicular article, an electronic article, a personal care article, a cleaning article, an athletic article, a food preparation article, a child care article, or an architectural article. More particularly, some examples of representative articles of these categories may include the following:
a) vehicular articles (e.g., automobile, bus, train, airplane, boat, ambulances, ships), such as head rests, dashboards, door panels, window shutter (e.g., of an airplane), gear shifter, seat belt buckle, instrument and button panels, arm rests, railings, luggage compartments, steering wheels, handlebars, etc.);
b) medical articles or dental articles including (e.g., non-sterile) surfaces of a medical, dental, or laboratory facility or medical, dental, or laboratory equipment (e.g., defibrillators, ventilators and CPAPs (especially masks thereof), face shields, crutches, wheelchairs, bed rails, breast pump devices, IV pole and bags, dental tools (e.g., hand tools used during dental cleaning and restoration procedures), curing lights (e.g., for dental materials), exam tables, asthma inhalers, etc.;
c) orthodontic articles including aligners (e.g., clear tray aligners), retainers, night guards, splints, class II and class III correctors, sleep apnea devices, bite openers, bands, brackets, buccal tubes, cleats, buttons, other attachment devices, etc.;
d) electronic articles including housings and cases of electronic devices (e.g., phones, laptops, tablets, or computers) as well as keyboards, mouses, projectors, printers, remote control devices, locks, chargers (including cords & docking stations), fobs, video and arcade games, slot machines, automatic teller machines; and point of sale electronic devices such as credit card readers, keypads, stylists, cash registers, barcode scanner, payment kiosks, etc.;
e) personal care articles including toothbrushes, eye glass frames, shoes, clothing, handbags, etc.;
f) cleaning articles including vacuums, mops, scrub brushes, dusters, toilet bowl cleaners, plungers, brooms, etc.;
g) athletic articles including helmets, guards, balls and hand-held equipment for various sports including baseball, lacrosse, tennis, football, basketball, soccer, and golf, etc.;
h) food preparation articles appliances (e.g., microwaves, stoves, ovens, blenders, toasters, coffee makers, refrigerators), grills, utensils (e.g., especially handles thereof), condiment bottles, salt & pepper shakers, galleys, carts, cutting boards, lunch boxes, thermoses, tables and chairs (especially for public dining in restaurants, dorms, nursing homes, and prisons), etc.;
i) child care articles including toys, pacifiers, bottles, teethers, car seats, cribs, changing tables, playground equipment, etc.; and
j) architectural articles including railings, countertops, desktops, cabinets, lockers, window sills, electrical modulators (e.g. light switches, dimmers, and outlets), components of furniture (e.g., desks, tables, chairs, seats and armrests); handles (e.g. knob, pull, levers including locks) of articles including furniture, doors of buildings, turn styles, appliances, vehicles, shopping carts and baskets, surfaces and components of lavatories (e.g. sink, toilet surfaces (e.g. levers), drain caps, shower walls, bathtub, vanity, countertop), etc.

The microstructured surface is particularly advantageous for congregate living facilities such as military housing, prisons, dorms, nursing homes, apartments, hotels; public places such as offices, schools, arenas, casinos, bowling alleys, golf courses, arcades, gyms, salons, spas, shopping centers, airports, train stations; and public transportation.

In select cases, the article comprises an orthodontic article. Optionally, the microstructured surface of the orthodontic aligner provides a first coefficient of friction that is different than a second coefficient of friction of a curve of the orthodontic aligner that lacks the microstructured surface. For instance, when the coefficient of friction is lower, microstructures can be included in locations of the orthodontic article where the teeth don't need to be moved, for greater comfort when worn by a user. Referring to FIGS. 8A-8D, an example is provided where the incisors need to be moved and that portion of the aligner lacks the microstructured surface, whereas the remaining teeth do not require adjustment and the remaining areas of the aligner include a microstructured surface over most of the interior cavity.

The term “microorganism” is generally used to refer to any prokaryotic or eukaryotic microscopic organism, including without limitation, one or more of bacteria (e.g., motile or nonmotile, vegetative or dormant, Gram positive or Gram negative, planktonic or living in a biofilm), bacterial spores or endospores, algae, fungi (e.g., yeast, filamentous fungi, fungal spores), mycoplasmas, and protozoa, as well as combinations thereof. In some cases, the microorganisms of particular interest are those that are pathogenic, and the term “pathogen” is used to refer to any pathogenic microorganism. Examples of pathogens can include, but are not limited to, both Gram positive and Gram negative bacteria, fungi, and viruses including members of the family Enterobacteriaceae, or members of the family Micrococaceae, or the genera Staphylococcus spp., Streptococcus, spp., Pseudomonas spp., Acinetobacter spp., Enterococcus spp., Salmonella spp., Legionella spp., Shigella spp., Yersinia spp., Enterobacter spp., Escherichia spp., Bacillus spp., Listeria spp., Campylobacter spp., Acinetobacter spp., Vibrio spp., Clostridium spp., Klebsiella spp., Proteus spp. Aspergillus spp., Candida spp., and Corynebacterium spp. Particular examples of pathogens can include, but are not limited to, Escherichia coli including enterohemorrhagic E. coli e.g., serotype O157:H7, 0129:H11; Pseudomonas aeruginosa; Bacillus cereus; Bacillus anthracis; Salmonella enteritidis; Salmonella enterica serotype Typhimurium; Listeria monocytogenes; Clostridium botulinum; Clostridium perfringens; Staphylococcus aureus; methicillin-resistant Staphylococcus aureus; carbapenem-resistant Enterobacteriaceae, Campylobacter jejuni; Yersinia enterocolitica; Vibrio vulnificus; Clostridium difficile; vancomycin-resistant Enterococcus; Klebsiella pnuemoniae; Proteus mirabilus and Enterobacter [Cronobacter] sakazakii.

### Exemplary Embodiments

In a first embodiment, the present disclosure provides a microstructured article. The microstructured article comprises a thermoplastic polymer shaped to comprise a curve comprising a curvature radius of up to 20 mm. At least a portion of the curve comprises a microstructured surface of utilitarian discontinuities. The microstructured surface comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees, and wherein the peak structures and the curve are formed of a single piece of the thermoplastic polymer. The peak structures and the curve are formed of a single piece of the thermoplastic polymer.

In a second embodiment, the present disclosure provides an article according to the first embodiment, wherein the microstructured surface is integral to the curve of the thermoplastic polymer.

In a third embodiment, the present disclosure provides an article according to the first embodiment or the second embodiment, wherein the thermoplastic polymer comprises a material that exhibits a draw down ratio of greater than 1.1.

In a fourth embodiment, the present disclosure provides an article according to any of the first through third embodiments, wherein the thermoplastic polymer comprises a material that exhibits an elongation at break of 50% or greater or 100% or greater.

In a fifth embodiment, the present disclosure provides an article according to any of the first through fourth embodiments, wherein the thermoplastic polymer comprises a polypropylene, a polyester, a co-polyester, a polycarbonate, a thermoplastic polyurethane, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, silicone urethane copolymer, fluoropolymer, a thermoplastic elastomer, or any combination thereof.

In a sixth embodiment, the present disclosure provides an article according to the fifth embodiment, wherein the thermoplastic polymer is shaped to comprise a second curve that lacks the microstructured surface.

In a seventh embodiment, the present disclosure provides an article according to any of the first through sixth embodiments, wherein the thermoplastic polymer is shaped to comprise a second curve that comprises a microstructured surface.

In an eighth embodiment, the present disclosure provides an article according to any of the first through sixth embodiments, wherein the valleys have a maximum width ranging from 10 microns to 250 microns and the peak structures have a side wall angle of greater than 10 degrees.

In a ninth embodiment, the present disclosure provides an article according to any of the first through eighth embodiments, wherein the peak structures each have a height of 10 microns to 250 microns.

In a tenth embodiment, the present disclosure provides an article according to any of the first through ninth embodiments, wherein the article is a medical article, a dental article, an orthodontic article, a vehicular article, an electronic article, a personal care article, a cleaning article, an athletic article, a food preparation article, a child care article, or an architectural article.

In an eleventh embodiment, the present disclosure provides an article according to any of the tenth embodiment, wherein the article is an orthodontic aligner, an orthodontic retainer, or a night guard.

In a twelfth embodiment, the present disclosure provides an article according to the eleventh embodiment, wherein the microstructured surface of the orthodontic aligner provides a first coefficient of friction that is different than a second coefficient of friction of a curve of the orthodontic aligner that lacks the microstructured surface.

In a thirteenth embodiment, the present disclosure provides an article according to any of the first through twelfth embodiments, wherein the portion of the curve comprising the microstructured surface comprises an interior portion.

In a fourteenth embodiment, the present disclosure provides an article according to any of the first through twelfth embodiments, wherein the portion of the curve comprising the microstructured surface comprises an exterior portion.

In a fifteenth embodiment, the present disclosure provides an article according to any of the first through fourteenth embodiments, wherein the peak structures have a height ranging from 10 to 125 microns.

In a sixteenth embodiment, the present disclosure provides an article according to any of the first through fifteenth embodiments, wherein the curve comprises a minimum curvature radius of 0.6 mm.

In a seventeenth embodiment, the present disclosure provides a method of making a microstructured article. The method comprises a) obtaining a tool shaped to comprise at least one of a protrusion or a concavity; b) disposing a microstructured film on at least a portion of the tool including the protrusion and/or the concavity; and c) thermoforming a single piece of thermoplastic polymer onto the tool to form a microstructured article shaped to comprise a curve comprising a curvature radius of up to 20 mm. The curve is an inverse of the protrusion or the concavity of the tool and at least a portion of the curve comprises a microstructured surface of utilitarian discontinuities being an inverse of a surface of the microstructured film. The microstructured surface comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

In an eighteenth embodiment, the present disclosure provides a method according to the seventeenth embodiment, when the microstructured film is attached to the thermoplastic polymer and steps b) and c) are performed at least partially simultaneously.

In a nineteenth embodiment, the present disclosure provides a method according to the eighteenth embodiment, wherein the microstructured film is thermoformed onto the tool simultaneously with step c).

In a twentieth embodiment, the present disclosure provides a method according to any of the seventeenth through nineteenth embodiments, wherein the microstructured film is disposed on only a portion of a thermoforming surface of the tool.

In a twenty-first embodiment, the present disclosure provides a method according to any of the seventeenth through twentieth embodiments, wherein the microstructured film is disposed on 90% or greater of a thermoforming surface of the tool.

In a twenty-second embodiment, the present disclosure provides a method according to the twenty-first embodiment, wherein a portion of the microstructured film is removed from the thermoforming surface of the tool prior to step c).

In a twenty-third embodiment, the present disclosure provides a method according to the twentieth embodiment or the twenty-second embodiment, wherein a geometry of the tool is configured to be smaller in a location where the microstructured film is disposed than in a location where the microstructured film is not disposed.

In a twenty-fourth embodiment, the present disclosure provides a method according to any of the seventeenth through twenty-third embodiments, wherein the tool is formed by additive manufacturing.

In a twenty-fifth embodiment, the present disclosure provides a method according to the twenty-fourth embodiment, wherein step a) comprises making the tool using an additive manufacturing process.

In a twenty-sixth embodiment, the present disclosure provides a method according to any of the seventeenth through twenty-fifth embodiments, wherein the microstructured film has an average thickness of 25 microns to 380 microns.

In a twenty-seventh embodiment, the present disclosure provides a method according to any of the seventeenth through twenty-sixth embodiments, wherein the microstructured film has a maximum land material thickness of less than 1 micron, less than 0.5 microns, or less than 0.3 microns.

In a twenty-eighth embodiment, the present disclosure provides a method according to any of the seventeenth through twenty-seventh embodiments, wherein the microstructured film is a reaction product of a composition comprising: a monomer having a Tg of no greater than 0° C., a monomer having a Tg of greater than 0° C., a polar monomer, polyvinyl butyral (PBV), and a crosslinker.

In a twenty-ninth embodiment, the present disclosure provides a method according to any of the seventeenth through twenty-eighth embodiments, wherein the microstructured article is the microstructured article of any of the first through sixteenth embodiments.

In a thirtieth embodiment, the present disclosure provides a tooling article. The tooling article comprises a tool shaped to comprise at least one of a protrusion or a concavity and a microstructured film disposed on at least a portion of the tool including the protrusion and/or the concavity. The microstructured film comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

In a thirty-first embodiment, the present disclosure provides a tooling article according to the thirtieth embodiment, wherein the peaks and valleys of the microstructured film are defined by a Cartesian coordinate system such that the peaks and valleys have a width and length in the x-y plane and a height in the z-direction and at least a portion of the peaks and/or valleys vary in height in the y direction by at least 10% of the average height.

In a thirty-second embodiment, the present disclosure provides a tooling article according to the thirtieth embodiment or thirty-first embodiment, wherein the peaks and valleys of the microstructured film are defined by a Cartesian coordinate system such that the peaks and valleys have a width and length in the x-y plane and a height in the z-direction and at least a portion of the peaks and/or valleys vary in height in the x direction by at least 10% of the average height.

In a thirty-third embodiment, the present disclosure provides a tooling article according to any of the thirtieth through thirty-second embodiments, wherein the microstructured film is disposed on only a portion of a thermoforming surface of the tool.

In a thirty-fourth embodiment, the present disclosure provides a tooling article according to any of the thirtieth through thirty-third embodiments, wherein the microstructured film is disposed on 90% or greater of a thermoforming surface of the tool.

In a thirty-fifth embodiment, the present disclosure provides a tooling article according to any of the thirtieth through thirty-fourth embodiments, wherein the tool has a shape of a dental arch.

### Examples

The following Examples are merely for illustrative purposes and are not meant to be overly limiting on the scope of the appended claims.

Unless otherwise noted or otherwise apparent from the context, all parts, percentages, ratios, and the like in the Examples and the rest of the specification are provided on the basis of weight. Solvents and other reagents used were obtained from Sigma-Aldrich Chemical Company (Milwaukee, WI) unless otherwise noted.

### Materials

5 mil (0.127 mm) PETG films were made by extruding pellets of PETG (obtained under the trade designation “EASTAR GN071” from Eastman Chemicals, Kingsport, TN) to a 5 mil thickness
Polypropylene disc, 125 mm diameter, 1.02 mm thick (obtained under the trade designation “INVISACRYL C” from Great Lakes Dental Technologies (formerly Great Lakes Orthodontics), Tonawanda, NY)
20 mil (0.508 mm) Microstructured Matte Polycarbonate film, (obtained under the trade designation “LEXAN 8B35” from Sabic, Mt. Vernon, IN)
2-Ethylhexyl acrylate (EHA) (obtained from BASF, Florham, NJ)
Acrylic acid (AA) (obtained from BASF, Florham, NJ)
Urethane acrylate oligomer (obtained under the trade designation “PHOTOMER 6210” from BASF, Florham, NJ)
Hexanediol diacrylate (obtained under the trade designation “SR238” from Sartomer Americas, Exton, PA)
Poly(vinyl butyral) (obtained under the trade designation “MOWITAL B60HH” from Kuraray, Houston, TX)
Photoinitiator, Bis(2,4,6-trimethylbenzoyl)-phenylphosphineoxide (obtained under the trade designation “IRGACURE 819” from BASF Corporation, Vandalia, IL)
Photoinitiator, 2,4,6-trimethylbenzoyldiphenyl phosphine oxide (obtained under the trade designation “LUCIRIN TPO” from BASF, Florham, NJ)

### Inspection Methods

The articles were visually inspected and examined with a digital microscope (obtained under the trade designation “KEYENCE VHX-1000” from Keyence Corporation of America, Itasca, IL).

### Sample Preparation Procedures

### Microstructured Metal Tool

A microstructured metal tool which had a structured surface described in Example 3 of co-owned PCT Application Publication No. WO 2023/105372 (Jones et al.), comprising a plurality of structures having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

### Procedure 1 Casting Coating and Method for Preparing Microstructured Films

Preparatory Base Syrup 1 for Procedure 1: Base Syrup was prepared by mixing the components in the amounts shown in Table 1 below as follows. Acrylic monomers and photoinitiator were combined in a gallon (3.79 liters) glass jar and mixed using a high shear electric motor to provide a homogeneous mixture. Next, B60HH was then added over a period of about three minutes with mixing. This was followed by further high speed mixing until a homogeneous, viscous solution was obtained. This was then degassed for ten minutes at a vacuum of 9.9 inches (252 millimeters) mercury.

### Table 1: Percentage and Amounts Used in Preparation of Base Syrup.

TABLE 1
Percentage and amounts used in preparation of Base Syrup.

| | EHA | AA | IRGACURE 819 | B60HH |
|---|---|---|---|---|
| Percentage | 66.5% | 16.6% | 0.2% | 16.6% |
| Grams Used | 1663.2 | 415.8 | 5.2 | 415.8 |

The coating resin for Procedure 1 was then prepared by adding 100 g of Base Syrup into a Speedmixer Cup along with 10 g of CN996 crosslinker and speed mixed in a Flacktec DAC 150.21 FVZ-K Speedmixer for 1 minute at 3000 rpm. The resin was coated onto a film substrate using a slot die. The resin-coated film was brought into contact with a tooling plate having a microstructured surface using pressure provided by a rotating nip roll at a given line speed. While the resin was in contact with the tool, the resin was cured using a high intensity Fusion Systems “D” lamp (from Fusion UV Curing Systems, Rockville, MD) with UV-A (315-400 nm) in the range of 100-1000 mJ/cm²

### Procedure 2 Casting Coating and Method for Preparing Microstructured Films

The resin system used in this procedure contained 75 parts urethane oligomer (“PHOTOMER 6210”), 25 parts hexanediol diacrylate (“SR238”) and 0.5 parts of photoinitiator (“LUCIRIN TPO”). The materials were blended with a high-speed mixer, and then heated in an oven at 160° F. (71° C.) for 24 hours. The compounded resin was subsequently cooled to room temperature and coated onto a film substrate using a slot die. The resin-coated film was brought into contact with a tooling plate having a microstructured surface using pressure provided by a rotating nip roll at a given line speed. While the resin was in contact with the tool, the resin was cured using a high intensity Fusion Systems “D” lamp (from Fusion UV Curing Systems, Rockville, MD) with UV-A (315-400 nm) in the range of 100-1000 mJ/cm².

### Procedure 3 Casting Coating and Method for Preparing Microstructured Films

The 3M proprietary resin named Wrigley referred to in Example 3 of U.S. Pat. No. 10,151,860 (Hao et al.) was coated onto a film substrate using a slot die. The resin-coated film was brought into contact with a tooling plate having a microstructured surface using pressure provided by a rotating nip roll at a given line speed. While the resin was in contact with the tool, the resin was cured using a high intensity Fusion Systems “D” lamp (from Fusion UV Curing Systems, Rockville, MD) with UV-A (315-400 nm) in the range of 100-1000 mJ/cm².

### Procedure 4 for Thermoforming

To thermoform, a 125 mm diameter substrate was heated for a specific time and then pulled down over a rigid-polymer dental arch model on a pressure molding machine (obtained under the trade designation “BIOSTAR VI” from Scheu-Dental GmbH, Iserlohn, Germany). The specific heating times were set at 14 seconds, 45 seconds, and 70 seconds for 5 mil PETG, polycarbonate, and polypropylene, respectively. The BIOSTAR VI chamber behind the film was pressurized to 90 psi (0.62 megapascals) for 15 seconds of cooling time, after which the chamber was vented to ambient pressure and the formed article and arch model were removed from the instrument and cooled down to room temperature under ambient condition. The model with the thermoformed substrate was removed from the machine and excess film was trimmed using an ultrasonic cutter (obtained under the trade designation “SONIC-CUTTER NE80” from Nakanishi Incorporated, Kanuma City, Japan)

### Comparative Example 1

An extrusion replicated matte polycarbonate film (“LEXAN 8B35”) was punched into a 125 mm diameter disc. The disc was thermoformed in the pressure molding machine (“BIOSTAR VI”) to a microstructured tooling film by Procedure 2 and trimmed with the ultrasonic cutter (“SONIC-CUTTER NE80”). The tooling film had good clarity and the matte (microstructured) surface was observed to have been erased by the heating and forming process of the thermoforming operation.

### Example 1

A microstructured PETG film was prepared by Procedure 1 described above, using the Microstructured Metal Tool as the tooling plate, from the 5 mil (0.127 mm) PETG film at a line speed of 20 fpm and 10 psi nip pressure and the shore hardness of the rubber nip roll was 95 A. The microstructure coated film was punched into a 125 mm disc. The disc was thermoformed onto a rigid-polymer dental arch model with its microstructure surface facing away from the dental arch model and trimmed to a microstructured tooling film by Procedure 4. The thermoformed microstructured tooling film had a uniform appearance.

### Example 2

A polypropylene disc (“INVISACRYL™ C”) was thermoformed over the microstructured tooling film of Example 1 using the thermoforming conditions of Procedure 4, to make a tray. After trimming with the ultrasonic cutter, the polypropylene tray was separated from the microstructured tooling film and the dental arch model by hand. The polypropylene tray had uniform appearance and the inversed structure of the microstructured surface of the tooling film was evident, when examined by microscope, on the surface of the cavity side of the polypropylene tray.

### Example 3

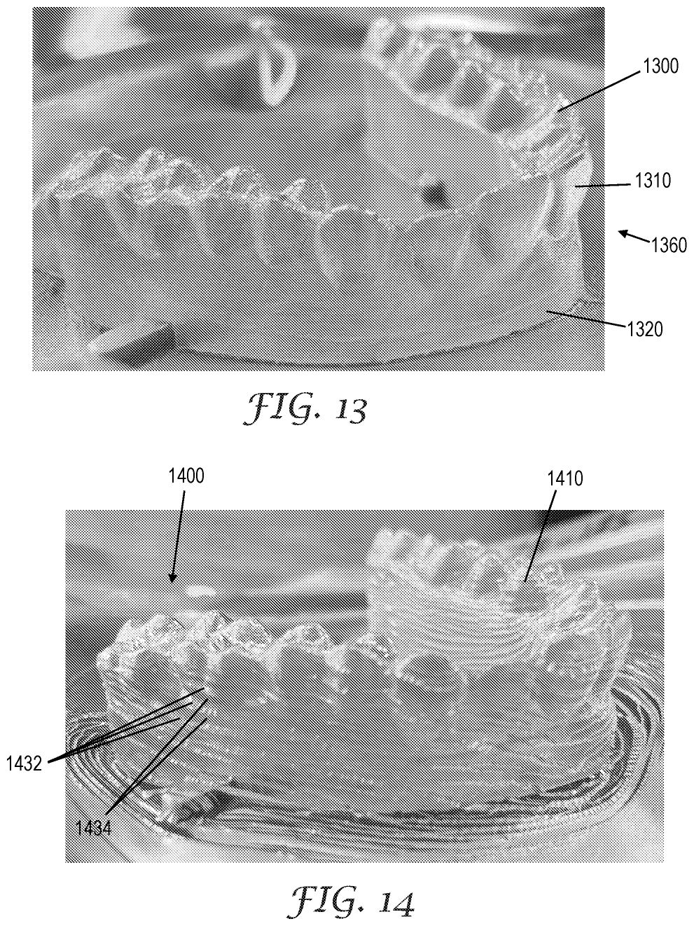

A microstructured PETG film was prepared by Procedure 2, using the Microstructured Metal Tool as the tooling plate, from the 5 mil (0.127 mm) PETG film at a line speed of 20 fpm and 10 psi nip pressure and the shore hardness of the rubber nip roll was 95 A. The minimum land thickness of the microstructured coating was determined to be less than 0.3 microns by microscope. The microstructure coated film was punched into a 125 mm disc. The disc was thermoformed onto a rigid-polymer dental arch model with its microstructured surface facing away from the dental arch model and trimmed to a microstructured tooling film by Procedure 4. Referring to FIG. 13, the thermoformed microstructured tooling film 1300 had a uniform appearance. Further, FIG. 13 shows another exemplary tooling article 1360 comprising a tool (e.g., having a shape of a dental arch) 1320 shaped to comprise at least one of a protrusion or a concavity, and a microstructured film 1300 disposed on at least a portion of the tool 1320 including the protrusion and/or the concavity.

### Example 4

A polypropylene disc (“INVISACRYL™ C”) was thermoformed over the microstructured tooling film of Example 3 using the thermoforming conditions of Procedure 4, to make a tray. After trimming with the ultrasonic cutter, the polypropylene tray was separated from the tooling film and the dental arch model by hand. The polypropylene tray had a uniform appearance and the inversed structure of the microstructure surface of the tooling film was evident, when examined by microscope, on the surface of the cavity side of the polypropylene tray.

### Comparative Example 2

A microstructured PETG film was prepared by Procedure 3, using the Microstructured Metal Tool as the tooling plate, from the 5 mil (0.127 mm) PETG film at a line speed of 20 fpm and 10 psi nip pressure and the shore hardness of the rubber nip roll was 95 A. The minimum land thickness of the microstructured coating was determined to be greater than 1 micron by microscope. The microstructure coated film was punched into a 125 mm disc. The disc was thermoformed onto a rigid-polymer dental arch model with its microstructured surface facing away from the dental arch model and trimmed to a microstructured tooling film by Procedure 4. Referring to FIG. 14, the thermoformed microstructured tooling film 1400 had tiger stripe patterns on the microstructured surface 1410, which are attributed to the macrocracks formed by deformation from the thermoforming operation. For instance, a microstructured tooling film 1400 having a striped pattern is formed by the presence of alternating areas of the tooling film 1400 having thicker material 1432 (e.g., more opaque) and thinner material 1434 (e.g., more transparent).

All of the patents and patent applications mentioned above are hereby expressly incorporated by reference. The embodiments described above are illustrative of the present invention and other constructions are also possible. Accordingly, the present invention should not be deemed limited to the embodiments described in detail above and shown in the accompanying drawings, but instead only by a fair scope of the claims that follow along with their equivalents.

1. A microstructured article comprising a thermoplastic polymer shaped to comprise a curve comprising a curvature radius of up to 20 mm, wherein at least a portion of the curve comprises a microstructured surface of utilitarian discontinuities, wherein the microstructured film comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees, and wherein the peak structures and the curve are formed of a single piece of the thermoplastic polymer.

2. The microstructured article of claim 1, wherein the microstructured surface is integral to the curve of the thermoplastic polymer.

3. The microstructured article of claim 1, wherein the thermoplastic polymer comprises a material that exhibits a draw down ratio of greater than 1.1.

4. The microstructured article of claim 1, wherein the thermoplastic polymer comprises a material that exhibits an elongation at break of 50% or greater or 100% or greater.

5. The microstructured article of claim 1, wherein the thermoplastic polymer comprises a polypropylene, a polyester, a co-polyester, a polycarbonate, a thermoplastic polyurethane, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, silicone urethane copolymer, fluoropolymer, or any combination thereof.

6. The microstructured article of claim 1, wherein the thermoplastic polymer is shaped to comprise a second curve that lacks the microstructured surface.

7. The microstructured article of claim 1, wherein the thermoplastic polymer is shaped to comprise a second curve that comprises a microstructured surface.

8. The microstructured article of claim 1, wherein the valleys have a maximum width ranging from 1 micron to 250 microns and the peak structures have a side wall angle of greater than 10 degrees.

9. The microstructured article of claim 1, wherein the peak structures each have a height of 10 micrometers to 250 micrometers.

10. The microstructured article of claim 1, wherein the article is a medical article, a dental article, an orthodontic article, a vehicular article, an electronic article, a personal care article, a cleaning article, an athletic article, a food preparation article, a child care article, or an architectural article.

11. The microstructured article of claim 1, wherein the article is an orthodontic aligner, an orthodontic retainer, or a night guard.

12. The microstructured article of claim 11, wherein the microstructured surface of the orthodontic aligner provides a first coefficient of friction that is different than a second coefficient of friction of a curve of the orthodontic aligner that lacks the microstructured surface.

13. A method of making a microstructured article, the method comprising:
a) obtaining a tool shaped to comprise at least one of a protrusion or a concavity;
b) disposing a microstructured film on at least a portion of the tool including the protrusion and/or the concavity; and
c) thermoforming a single piece of thermoplastic polymer onto the tool to form a microstructured article shaped to comprise a curve comprising a curvature radius of up to 20 mm, the curve being an inverse of the protrusion or the concavity of the tool, wherein at least a portion of the curve comprises a microstructured surface of utilitarian discontinuities being an inverse of a surface of the microstructured film, wherein the microstructured surface comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

14. The method of claim 13, when the microstructured film is attached to the thermoplastic polymer and steps b) and c) are performed at least partially simultaneously.

15. The method of claim 14, wherein the microstructured film is thermoformed onto the tool simultaneously with step c).

16. The method of claim 13, wherein the microstructured film is disposed on only a portion of a thermoforming surface of the tool.

17. The method of claim 13, wherein the microstructured film is disposed on 90% or greater of a thermoforming surface of the tool.

18. The method of claim 17, wherein a portion of the microstructured film is removed from the thermoforming surface of the tool prior to step c).

19. The method of claim 16, wherein a geometry of the tool is configured to be smaller in a location where the microstructured film is disposed than in a location where the microstructured film is not disposed.

20. The method of claim 19, wherein step a) comprises making the tool using an additive manufacturing process.

21. The method of claim 13, wherein the microstructured film has an average thickness of 25 micrometers to 380 micrometers.

22. The method of claim 13, wherein the microstructured film has a maximum land material thickness of less than 1 micrometer, less than 0.5 micrometers, or less than 0.3 micrometers.

23. The method of claim 13, wherein the microstructured film is a reaction product of a composition comprising: a monomer having a Tg of no greater than 0° C., a monomer having a Tg of greater than 0° C., a polar monomer, polyvinyl butyral (PBV), and a crosslinker.

24. A tooling article comprising:
a) a tool shaped to comprise at least one of a protrusion or a concavity; and
b) a microstructured film disposed on at least a portion of the tool including the protrusion and/or the concavity, wherein the microstructured film comprises peak structures and adjacent valleys having a complement cumulative slope magnitude distribution (Fcc) such that at least 30, 40, 50, 60, 70, 80 or 90% of the structures have a slope greater than 10 degrees; and less than 80% of the structures have a slope greater than 35 degrees.

25. The tooling article of claim 24, wherein the peaks and valleys of the microstructured film are defined by a Cartesian coordinate system such that the peaks and valleys have a width and length in the x-y plane and a height in the z-direction and at least a portion of the peaks and/or valleys vary in height in the y direction by at least 10% of the average height.

26. The tooling article of claim 24, wherein the peaks and valleys of the microstructured film are defined by a Cartesian coordinate system such that the peaks and valleys have a width and length in the x-y plane and a height in the z-direction and at least a portion of the peaks and/or valleys vary in height in the x direction by at least 10% of the average height.

27. The tooling article of claim 24, wherein the microstructured film is disposed on only a portion of a thermoforming surface of the tool.

28. The tooling article of claim 24, wherein the microstructured film is disposed on 90% or greater of a thermoforming surface of the tool.

29. The tooling article of claim 24 wherein the tool has a shape of a dental arch.
